(19) United States
(12) Patent Application Publication
(10) Pub. No.: US 2026/0143160 A1
(43) Pub. Date: May 21, 2026

(54) DISPLACEMENT DATA CODING FOR DYNAMIC MESH CODING

(71) Applicant: Bytedance Inc., Los Angeles, CA (US)

(72) Inventor: Jizheng XU, San Diego, CA (US)

(21) Appl. No.: 19/444,836

(22) Filed: Jan. 9, 2026

Related U.S. Application Data
(63) Continuation of application No. PCT/US2024/037215, filed on Jul. 9, 2024.
(60) Provisional application No. 63/512,827, filed on Jul. 10, 2023.

(51) Int. Cl. H04N 19/54; H04N 19/105; H04N 19/159; H04N 19/186; H04N 19/597

(52) U.S. Cl. CPC H04N 19/54; H04N 19/105; H04N 19/159; H04N 19/186; H04N 19/597

(57) ABSTRACT

A mechanism for processing video data is disclosed. The mechanism includes determining to process displacement data coded in a 4:2:2 video format the same as displacement data coded in a 4:2:0 video format. A conversion is performed between a visual media data and a bitstream based on the displacement data.

### CROSS-REFERENCE TO RELATED APPLICATIONS

This patent application is a continuation of International Patent Application No. PCT/US2024/037215 filed on Jul. 9, 2024, which claims the priority to and the benefits of U.S. Patent Application No. 63/512,827 filed on Jul. 10, 2023. The entire disclosure of the aforementioned applications is incorporated by reference as part of the disclosure of this application.

### TECHNICAL FIELD

The present disclosure relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising: determining to process displacement data coded in a 4:2:2 video format the same as displacement data coded in a 4:2:0 video format; and performing a conversion between a visual media data and a bitstream based on the displacement data.

Optionally, in any of the preceding aspects, another implementation of the aspect provides that when a displacement dimension (DisplacementDim) is equal to 1, a first displacement component is derived from a first color component of a video and a second displacement component and a third displacement component are inferred to be 0.

Optionally, in any of the preceding aspects, another implementation of the aspect provides that when a displacement dimension (DisplacementDim) is equal to 3, a first displacement component, a second displacement component, and a third displacement component are derived from a first color component of the video.

Optionally, in any of the preceding aspects, another implementation of the aspect provides that a subblock size of alternating current (AC)-based displacement coding is constrained to being greater than a particular value.

Optionally, in any of the preceding aspects, another implementation of the aspect provides that the subblock size of AC-based displacement coding is constrained to being greater than 0.

Optionally, in any of the preceding aspects, another implementation of the aspect provides that the subblock size of AC-based displacement coding is constrained to being greater than 1.

Optionally, in any of the preceding aspects, another implementation of the aspect provides determining to process displacement data coded in a 4:0:0 video format the same as the displacement data coded in a 4:2:0 video format.

Optionally, in any of the preceding aspects, another implementation of the aspect provides that when the displacement data is coded in the 4:0:0 video format and a displacement dimension (DisplacementDim) is equal to 1, a first displacement component is derived from a first color component of a video and a second displacement component and a third displacement component are inferred to be 0.

Optionally, in any of the preceding aspects, another implementation of the aspect provides that when the displacement data is coded in the 4:0:0 video format and a displacement dimension (DisplacementDim) is equal to 3, a first displacement component, a second displacement component, and a third displacement component are derived from a first color component of the video,

Optionally, in any of the preceding aspects, another implementation of the aspect provides that aligning a coding type of alternating current (AC)-based displacement coding with a coding type of a submesh.

Optionally, in any of the preceding aspects, another implementation of the aspect provides that when a coding type of the current submesh (smh_type) indicates intra coding, a coding type of a current displacement frame (displ_type) is not signalled in the bitstream and is inferred to be intra coded.

Optionally, in any of the preceding aspects, another implementation of the aspect provides that when a coding type of a current displacement frame (displ_type) indicates intra coding, a coding type of the current submesh (smh_type) is not signalled in the bitstream and is inferred to be intra coded.

Optionally, in any of the preceding aspects, another implementation of the aspect provides that the smh_type has a submesh type of I_SUBMESH, and wherein the displ_type has a type of I_DISPLACEMENT.

Optionally, in any of the preceding aspects, another implementation of the aspect provides that when a coding type of the current submesh (smh_type) indicates inter coding, a coding type of a current displacement frame (displ_type) is not signalled in the bitstream and is inferred to be inter coded.

Optionally, in any of the preceding aspects, another implementation of the aspect provides that when a coding type of a current displacement frame (displ_type) indicates inter coding, a coding type of the current submesh (smh_type) is not signalled in the bitstream and is inferred to be inter coded.

Optionally, in any of the preceding aspects, another implementation of the aspect provides that the smh_type has a submesh type of P_SUBMESH or SKIP_SUBMEDH, and wherein the displ_type has a type of P_DISPLACEMENT.

Optionally, in any of the preceding aspects, another implementation of the aspect provides that when a submesh at a first time (t1) uses a submesh at a second time (t2) as a reference, displacement data at the first time only uses displacement data at the second time as a reference.

Optionally, in any of the preceding aspects, another implementation of the aspect provides that a reference index for displacement data is set equal to a reference index for submesh.

Optionally, in any of the preceding aspects, another implementation of the aspect provides that a displacement reference list structure is set equal to a base mesh reference list structure.

Optionally, in any of the preceding aspects, another implementation of the aspect provides that the base mesh reference list structure is designated bmesh_ref_list_struct.

Optionally, in any of the preceding aspects, another implementation of the aspect provides that one or more of the 4:2:2 video format, the 4:0:0 video format, and the 4:2:0 video format comprise a chroma video format (videoChromaFormat).

Optionally, in any of the preceding aspects, another implementation of the aspect provides that one or more of the 4:2:2 video format, the 4:0:0 video format, and the 4:2:0 video format comprise a decoding geometry video format (DecGoeChromaFormat).

Optionally, in any of the preceding aspects, another implementation of the aspect provides that the conversion includes encoding the media data into the bitstream.

Optionally, in any of the preceding aspects, another implementation of the aspect provides that the conversion includes decoding the media data from the bitstream.

A second aspect relates to an apparatus for processing video data comprising: a processor; and a non-transitory memory with instructions thereon, wherein the instructions upon execution by the processor, cause the processor to perform any of the disclosed methods.

A third aspect relates to non-transitory computer readable medium comprising a computer program product for use by a video coding device, the computer program product comprising computer executable instructions stored on the non-transitory computer readable medium such that when executed by a processor cause the video coding device to perform the any of the disclosed methods.

A fourth aspect relates to a non-transitory computer-readable recording medium storing a bitstream of a video which is generated by a method performed by a video processing apparatus, wherein the method comprises: determining to process displacement data coded in a 4:2:2 video format the same as displacement data coded in a 4:2:0 video format; and generating the bitstream based on the displacement data.

A fifth aspect relates to a method for storing bitstream of a video, comprising: determining to process displacement data coded in a 4:2:2 video format the same as displacement data coded in a 4:2:0 video format; generating the bitstream with the based on the displacement data; and storing the bitstream in a non-transitory computer-readable recording medium.

A sixth aspect relates to a method, apparatus, or system described in the present disclosure.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram illustrating a decoder design of dynamic mesh coding.

FIG. 2 is a block diagram illustrating a structure of a dynamic mesh coding test model.

FIG. 3 is a block diagram showing an example video processing system.

FIG. 4 is a block diagram of an example video processing apparatus.

FIG. 5 is a flowchart for an example method of video processing.

FIG. 6 is a block diagram that illustrates an example video coding system.

FIG. 7 is a block diagram that illustrates an example encoder.

FIG. 8 is a block diagram that illustrates an example decoder.

FIG. 9 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

### 1. Initial Discussion

This disclosure is related to improvements to motion picture experts group immersive (MPEG-I) video-based dynamic mesh coding. It may be also applicable to other immersive video coding standards or codecs.

### 2. Further Discussion

In computer graphics, a three dimensional (3D)/immersive content can usually be represented by a 3D mesh and a texture map. Those mesh and texture data can be generated by a machine or can be converted from images captured by multiple cameras from different angles. Similar to two-dimensional (2D) video, when those 3D contents change with time, the mesh and texture data also change and consist a sequence of dynamic mesh. The data volume of dynamic mesh is usually huge and makes it difficult to store and transmit. To meet the requirement of applications that use dynamic mesh, Motion Picture Expert Group (MPEG) in short, issued a call for proposal [1]. To efficiently use the 2D codecs that are already available, one of the key requirements is to use the current 2D video coding standard to compress most data and keep other parts simple and of low complexity. Such a requirement can guarantee that the representation can take advantages of the 2D video hardware/software systems, without much efforts to redesign a specific system just for dynamic mesh.

MPEG received 5 responses to the call for proposal. Among them, a scheme [2] showed better performance compared with others. So based on [2], a test model was built for the development of the planned dynamic mesh coding standard.

The latest test model of dynamic mesh coding until this disclosure is drafted can be found via this link http://mpegx.int-evry.fr/software/MPEG/dmc/mpeg-vmesh-tm/-/tags/v4.0; and the latest working draft document is WD 3.0 [3].

### 2.1 Data Representation in Dynamic Mesh Coding

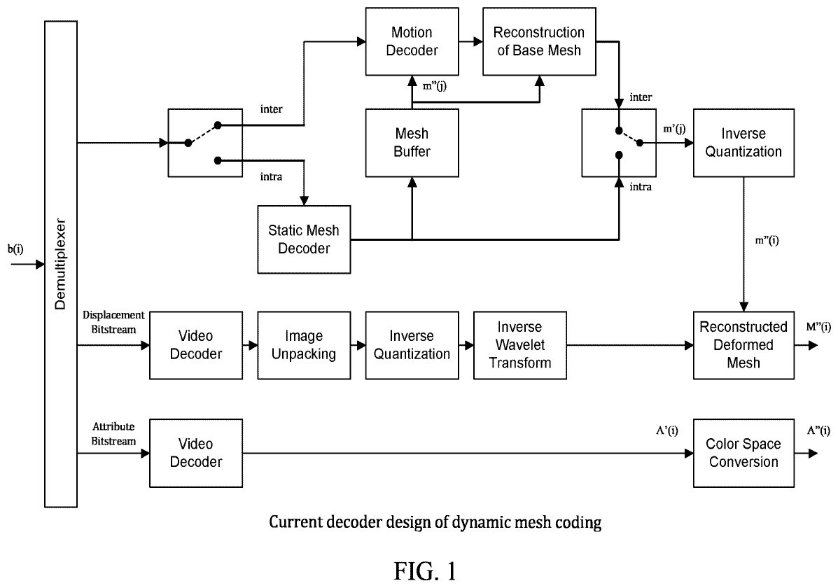

FIG. 1 is a block diagram illustrating a decoder design of dynamic mesh coding. FIG. 1 shows a decoder design as described in WD 1.0 [3]. It can be seen that a dynamic mesh decoder receives 3 bitstreams and performs decoding to reconstruct the dynamic mesh plus texture signals. The first bitstream is to represent the base mesh, which is a decimated version of the original mesh. The second bitstream is to represent displacement vectors between the reconstructed base mesh and the original mesh. The displacement vectors are arranged as a 2D video and compressed with an 2D video coding standard compliant codec. The third bitstream is to represent the texture (or attribute map). The attribute map is also arranged as a 2D video and compressed with an 2D video coding standard compliant codec. The design philosophy is to make the base mesh part small enough so that the module to process base mesh can be implemented simply. On the other hand, the displacement vectors and the attribute map accounts for most volume of the whole dynamic mesh data, which can be processed with the current dedicated highly efficient 2D video coding systems. Such a design can reduce the extra efforts to implement the dynamic mesh coding system and guarantee the high throughout and coding efficiency for the dynamic mesh data.

### 2.2 Test Model of Dynamic Mesh Coding

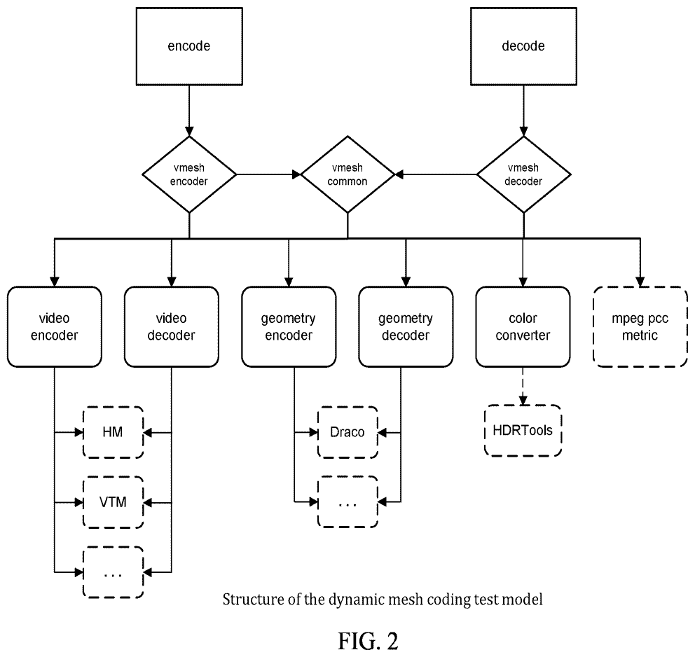

FIG. 2 is a block diagram illustrating a structure of a dynamic mesh coding test model. FIG. 2 shows the structure of an example dynamic mesh coding model. In the model, Draco is used to compress base mesh and the High Efficiency Video Coding (HEVC) test model, e.g., HM is used to compress displacement vectors and attribute map. However, it should be noted that other mesh or video coding systems can also be used in dynamic mesh coding.

The base mesh m is generated from the original mesh with a down-sampling scheme. Its quantized version m′ is then coded using Draco. The reconstrused base mesh m″ can be obtained by inverse quantization of m′. Displacement vectors d′ are generated by making the difference between the original mesh and the subdivided version of m″ using a subdivision scheme.

### 2.3 Coding of Displacement Vectors

After obtaining displacement vectors d′, the difference between the original mesh and the subdivided base mesh, a lifting-based wavelet transform is applied to further make the energy compact. Then the wavelet transform coefficients are traversed from low to high frequency using a Morton order to form 2D coefficient blocks. Various 2D coefficient blocks comprise a picture to be processed by a 2D codec.

### 2.4 Motion Field Coding

In the test model, motion fields between base meshes are directly coded using arithmetic coding. Proposal [4] investigates coding of motion fields also with a standard compliant 2D coding system and showed that the coding efficiency loss is marginal. Thus, it may make sense to further shift the coding process of motion field to a 2D video codec.

### 2.5 Chroma Formats

In H.264/Advanced Video Coding (AVC), H.265/HEVC and H.266/Versatile Video Coding (VVC), different chroma formats are supported. The format may be signalled by the syntax element sps_chroma_format_idc and represented by the variable ChromaFormatIdc. The following table illustrates the chroma formats corresponding to different sps_chroma_format_idc:

| sps_chroma_{—} | Chroma |
|---|---|
| format_idc | format |
| 0 | Monochrome |
| 1 | 4:2:0 |
| 2 | 4:2:2 |
| 3 | 4:4:4 |

### 2.6 Lossless Coding

In H.264/AVC and H.266/VVC, lossless coding can be achieved by setting quantization parameters (QP) to be 4 and applying an invertible spatial transform or transform skipping to the block. In H.265/HEVC, in addition to the above method, lossless coding can also be achieved by setting the cu_transquant_bypass_flag of a coding unit to be 1.

### 2.7 Other Designs

In an earlier example design, ideas are presented to combine multiple attributes, including texture, displacement data, occupancy data into one video for encoding/decoding without requiring multiple encoding/decoding capabilities on a device; colour space for lossless texture coding and subblock size signalling for arithmetic coding-based displacement coding.

### 2.8 Inverse Packing of Displacement Data

In an example Video-Based Dynamic Mesh Coding (V-DMC) design, when displacement data are coded as a 4:0:0 video, the 1st displacement component is derived from the 1st colour component and the 2nd and 3rd displacement components are inferred to be 0; when displacement data are coded as a 4:4:4 video, the 1st, 2nd and 3rd displacement components are derived from the 1st, 2nd and 3rd colour components of the video, respectively; when displacement data are coded as a 4:2:0 video and asps_vdmc_ext_1d_displacement_flag is equal to 1, the 1st displacement component is derived from the 1st colour component of the video and the 2nd and 3rd displacement components are inferred to be 0; when displacement data are coded as a 4:2:0 video and asps_vdmc_ext_1d_displacement_flag is equal to 0, the 1st, 2nd and 3rd displacement components are all derived from the 1st colour component of the video. The corresponding description in working draft (WD) 3.0 is as follows:

8.4.6.1.3 Atlas Sequence Parameter Set vdmc Extension RBSP Syntax

asps_vdmc_ext_subdivision_method indicates the identifier of the method to subdivide the meshes associated with the current atlas sequence parameter set. Table 2 describes the list of supported subdivision methods and their relationship with asps_vdmc_ext_subdivision_method.

TABLE 2

| asps_vdmc_ext_{—} | Name of |
|---|---|
| subdivision_method | subdivision method |
| 0 | NONE |
| 1 | MIDPOINT |

asps_vdmc_ext_subdivision_iteration_count indicates the number of iterations used for the subdivision. When not present the value of asps_vdmc_ext_subdivision_iteration_count is inferred to be equal to 0.

asps_vdmc_ext_displacement_coordinate_system indicates the identifier of the coordinate system for the meshes associated with the current atlas sequence parameter set. Table 3 describes the list of supported displacement coordinate system and their relationship with asps_vdmc_ext_displacement_coordinate_system.

TABLE 3

| asps_vdmc_ext_displacement_{—} | Name of displacement |
|---|---|
| coordinate_system | coordinate system |
| 0 | CANNONICAL |
| 1 | LOCAL |

asps_vdmc_ext_transform_method indicates the identifier of the transform applied to the displacement. Table 4 describes the list of supported transforms and their relationship with asps_vdmc_ext_transform_method.

TABLE 4

| asps_vdmc_ext_{—} | Name of |
|---|---|
| transform_method | transform method |
| 0 | NONE |
| 1 | LINEAR_LIFTING |

asps_vdmc_ext_num_attribute_video indicates the number of the attributes signalled through the video sub-bitstreams.

asps_vdmc_ext_attribute_type_id[i] indicates the attribute type of the Attribute Video Data unit with index i.

asps_vdmc_ext_attribute_frame_width[i] indicates the atlas frame width of the Attribute Video Data unit with index i in terms of integer luma samples for the atlas with atlas ID j. It is a requirement of V3C bitstream conformance that the value of asps_vdmc_ext_attribute_frame_width[i] shall be equal to the value of vps_ext_attribute_frame_width[j][i], where j is the ID of the current atlas.

asps_vdmc_ext_attribute_frame_height[i] indicates the atlas frame height of the Attribute Video Data unit with index i in terms of integer luma samples for the atlas with atlas ID j. It is a requirement of V3C bitstream conformance that the value of asps_vdmc_ext_attribute_frame_height[i] shall be equal to the value of vps_ext_attribute_frame_height[j][i], where j is the ID of the current atlas.

asps_vdmc_ext_attribute_transform_method[i] the identifier of the transform applied to the attribute signalled in the Attribute Video Data unit with index i. Table 5 describes the list of supported transforms and their relationship with asps_vdmc_ext_attribute_transform_method.

TABLE 5

| asps_vdmc_ext_attribute_{—} | Name of |
|---|---|
| transform_method | transform method |
| 0 | NONE |
| 1 | LINEAR_LIFTING |

asps_vdmc_ext_direct_attribute_projection_enabled_flag[i] equal to 0 specifies that the patch projection information is not signalled for the attribute signalled in the Attribute Video Data unit with index i in a patch data unit or a raw patch data unit. asps_vdmc_ext_direct_attribute_projection_enabled_flag[i] equal to 1 specifies that the patch projection information is signalled for the attribute signalled in the Attribute Video Data unit with index i in a patch data unit or a raw patch data unit.

asps_vdmc_ext_packing_method equal to 0 specifies that the displacement component samples are packed in ascending order, asps_vdmc_ext_packing_method equal to 1 0 specifies that the displacement component samples are packed in descending order.

asps_vdmc_ext_1d_displacement_flag equal to 1 specifies that only the normal (or x) component of the displacement is present in the compressed geometry video. The remaining two components are inferred to be 0. asps_vdmc_ext_1D_displacement_flag equal to 0 specifies that all 3 components of the displacement are present in the compressed geometry video.

asps_vdmc_ext_projection_textcoord_enable_flag equal to 0 specifies that the texture coordinates may be transmitted in the base mesh, asps_vdmc_ext_projection_textcoord_enable_flag equal to 1 specifies that the texture coordinates will be derived using projection parameters from the meshpatch data unit.

asps_vdmc_ext_projection_textcoord mapping method indicates the identifier of the variable FaceToSubPatchMapping, which indicates the method to map a set of faces to a sub-patch. Table 6 describes the list of supported faces to sub-patch mapping methods and their relationship with the variable FaceToSubPatchMapping.

TABLE 6
FaceToSubPatchMapping

| | |
|---|---|
| 0 | The first component of the texture |
| | coordinate of the submesh is used |
| 1 | A faceID attribute of the submesh is used |
| 2 | Connected Components is used |

asps_vdmc_ext_projection_textcoord_scale_factor indicates the value of the scaling factor variable TextCoordProjectionScaleFactor, that is used for texture coordinate derivation from geometry projection.

### 11.5 Inverse Image Packing of Wavelet Coefficients

Inputs to this process are:
width, which is a variable indicating the width of the displacements video frame,
height, which is a variable indicating the height of the displacements video frame,
bitDepth, which is a variable indicating the bit depth of the displacements video frame,
dispQuantCoeffFrame, which is a 3D array of size width×height×3 indicating the packed quantized displacement wavelet coefficients.
blockSize, which is a variable indicating the size of the displacements coefficients blocks,
verCoordCount, which is a variable indicating the number of vertex coordinates in the subdivided submesh.

The output of this process is dispQuantCoeffArray, which is a 2D array of size verCoordCount×3 indicating the quantized displacement wavelet coefficients.

It is a requirement of bitstream conformance that when DecGeoChromaFormat is equal to 4:0:0, asps_vdmc_ext_1d_displacement_flag shall be equal to 1. It is also a requirement of bitstream conformance that when DecGeoChromaFormat is equal to 4:4:4, asps_vdmc_ext_1d_displacement_flag shall be equal to 0.

The 2D array dispQuantCoeffArray is initialized to 0. The variable DisplacementDim is set as follows:
if asps_vdmc_ext_1d_displacement_flag is equal to 1, DisplacementDim is set to 1
otherwise, asps_vdmc_ext_1d_displacement_flag is equal to 0, DisplacementDim is set to 3

Let the function extracOddBits(x) be defined as follows:

```
x = extracOddBits( x ) {
  x = x & 0x55555555
  x = ( x | ( x >> 1 ) ) & 0x33333333
  x = ( x | ( x >> 2 ) ) & 0x0F0F0F0F
  x = ( x | ( x >> 4 ) ) & 0x00FF00FF
  x = ( x | ( x >> 8 ) ) & 0x0000FFFF
}
```

Let the function computeMorton2D(i) be defined as follows:

```
( x, y) = computeMorton2D( i ) {
  x = extracOddBits( i >> 1 )
  y = extracOddBits( i )
}
```

The wavelet coefficients inverse packing process proceeds as follows:

```
pixelsPerBlock = blockSize * blockSize
widthInBlocks = width / blockSize
shift = (1 << bitDepth) >> 1
blockCount = (verCoordCount + pixelsPerBlock − 1) / pixelsPerBlock
heightInBlocks = (blockCount + widthInBlocks − 1) / widthInBlocks
origHeight = heightInBlocks * blockSize
paddedHeight = height − 3 * origHeight
if ( !asps_vdmc_ext_1d_displacement_flag )
  start = (paddedHeight + origHeight) * width − 1
else
  start = (width * height) − 1
for( v = 0; v < verCoordCount; v++ ) {
  v0 = asps_vdmc_ext_packing_method ? start − v : v
  blockIndex = v0 / pixelsPerBlock
  indexWithinBlock = v0 % pixelsPerBlock
  x0 = ( blockIndex % widthInBlocks ) * blockSize
  y0 = ( blockIndex / widthInBlocks ) * blockSize
  ( x, y ) = computeMorton2D( indexWithinBlock )
  x1 = x0 + x
  y1 = y0 + y
  for( d = 0; d < DisplacementDim; d++ ) {
    if ( DecGeoChromaFormat == 4:2:0 ) {
      dispQuantCoeffArray[ v0 ][ d ] =
        dispQuantCoeffFrame[ x1 ][ d * origHeight + y1 ][ d0 ] − shift
    } else {
      dispQuantCoeffArray[ v0 ][ d ] = dispQuantCoeffFrame[ x1 ][
      y1 ][ d ] − shift
    }
  }
}
```

### 2.9 Basemesh Submesh Coding Syntax and Semantics

Descriptor

```
bmesh_submesh_layer_rbsp( ) {
  submesh_header( )
  submesh_data_unit( mfh_submesh_type,
  SubMeshUnitSize )
  rbsp_trailing_bits( )
}
```

### H.8.1.3.4 Basemesh Submesh Header Syntax

| | Descriptor |
|---|---|
| submesh_header( ) { | |
| if( nal_unit_type >= NAL_BLA_W_LP && nal_unit_type <= NAL_RSV_IRAP_ACL | |
| _29 ) | |
| smh_no_output_of_prior_mesh_frames_flag | u(1) |
| smh_basemesh_frame_parameter_set_id | u(4) |
| smh_id | u(v) |
| subMeshID = smh_id | |
| smh_type | ue(v) |
| if( bfps_output_flag_present_flag ) | |
| smh_mesh_output_flag | u(1) |
| smh_mesh_frm_order_cnt_lsb | u(v) |
| if( bmsps_num_ref_mesh_frame_lists_in_bmsps > 0 ) | |
| smh_ref_mesh_frame_list_msps_flag | u(1) |
| if( smh_ref_basemesh_frame_list_msps_flag == 0 ) | |
| basemesh_ref_list_struct( bmsps_num_ref_mesh_frame_lists_in_bmsps ) | |
| else if( bmsps_num_ref_mesh_frame_lists_in_bmsps > 1 ) | |
| smh_ref_mesh_frame_list_idx | u(v) |
| for( j = 0; j < NumLtrMeshFrmEntries[ RlsIdx ]; j++ ) { | |
| smh_additional_mfoc_lsb_present_flag[ j ] | u(1) |
| if( smh_additional_mfoc_lsb_present_flag[ j ] ) | |
| smh_additional_mfoc_lsb_val[ j ] | u(v) |
| } | |
| if( smh_type != SKIP_SUBMESH ) { | |
| if( smh_type == P_SUBMESH && num_ref_entries[ RlsIdx ] > 1 ) { | |
| smh_num_ref_idx_active_override_flag | u(1) |
| if( smh_num_ref_idx_active_override_flag ) | |
| smh_num_ref_idx_active_minus1 | ue(v) |
| } | |
| } | |
| byte_alignment( ) | |
| } | |

### H.8.1.3.5 Reference List Structure Syntax

| | Descriptor |
|---|---|
| bmesh_ref_list_struct( rlsIdx ) { | |
| num_ref_entries[ rlsIdx ] | ue(v) |
| for( i = 0; i < num_ref_entries[ rlsIdx ]; i++ ) { | |
| if( bmsps_long_term_ref_mesh_frames_flag ) | |
| st_ref_mesh_frame_flag[ rlsIdx ][ i ] | u(1) |
| if( st_ref_mesh_frame_flag[ rlsIdx ][ i ] ) { | |
| abs_delta_mfoc_st[ rlsIdx ][ i ] | ue(v) |
| if( abs_delta_mfoc_st[ rlsIdx ][ i ] > 0 ) | |
| straf_entry_sign_flag[ rlsIdx ][ i ] | u(1) |
| } else | |
| mfoc_lsb_lt[ rlsIdx ][ i ] | u(v) |
| } | |
| } | |

### H.8.3.3 Basemesh Submesh Layer RBSP Semantics

### H.8.3.4 Basemesh Submesh Header Semantics

When present, the value of the atlas tile header syntax elements smh_basemesh_frame_parameter_set_id, smh_mesh_output_flag, snmh_no_output_ofprior_mesh_frames_flag, and smh_mesh_frm_order_cnt_lsb, shall be the same in all submesh headers of a coded mesh frame.

smh_no_output_of_prior_mesh_frames_flag affects the output of previously-decoded mesh frames in the DAB after the decoding of an atlas in a CAS AU that is not the first AU in the bitstream. When smh_no_output_of_prior_mesh_frames_flag is not present, its value is inferred to be equal to 0.

It is a requirement of bitstream conformance that the value of smh_no_output_of_prior_mesh_frames_flag shall be the same for all mesh frames in an AU.

The value of smh_no_output_of_prior_mesh_frames_flag in the submesh headers is also referred to as the output_of_prior_mesh_frames_flag value of the AU.

smh_basemesh_frame_parameter_set_id specifies the value of bfps_basemesh_frame_parameter_set_id for the active basemesh frame parameter set for the current submesh.

smh_id specifies the submesh ID associated with the current submesh. When not present, the value of smh_id is inferred to be equal to 0.

The following applies:
The length of smh_id is bmsi_signalled_submesh_id_length_minus1+1 bits.
The value of smh_id shall be in the range of values specified by the array SubMeshIndexToID [i], for i in the range from 0 to bsmi_num_submeshes_minus1, inclusive.

It is a requirement of bitstream conformance that the following constraints apply:
The value of smh_id shall not be equal to the value of smh_id of any other coded atlas tile unit of the same coded atlas frame.
The tiles of an atlas frame shall be in increasing order of their smh_id values.

smh_type specifies the coding type of the current submesh according to Table 8. The value of smh_type shall be equal to 0, 1, or 2 in bitstreams conforming to this version of this document. Other values of smh_type are reserved for future use by ISO/JEC. Decoders conforming to this version of this document shall ignore reserved values of smh_type.

TABLE 8
Name association to smh_type

| smh_type | Name of smh_type |
|---|---|
| 0 | P_SUBMESH |
| 1 | I_SUBMESH |
| 2 | SKIP_SUBMESH |
| 3- . . . | RESERVED |

smh_mesh_output_flag affects the decoded mesh output and removal processes. When smh_mesh_output_flag is not present, it is inferred to be equal to 1.

smh_mesh_frm_order_cnt_lsb specifies the mesh frame order count modulo MaxMeshFrmOrderCntLsb for the current submesh. The length of the smh_mesh_frm_order_cnt_lsb syntax element is equal to Log 2MaxMeshFrmOrderCntLsb bits. The value of the smh_mesh_frm_order_cnt_lsb shall be in the range of 0 to MaxMeshFrmOrderCntLsb−1, inclusive.

smh_ref_mesh_frame_list_bmsps_flag equal to 1 specifies that the reference bmesh frame list of the current submesh is derived based on one of the bmesh_ref_list_struct(rlsIdx) syntax structures in the active BMSPS. smh_ref_mesh_frame_list_bmsps_flag equal to 0 specifies that the reference bmesh frame list of the current submesh is derived based on the bmesh_ref_list_struct(rlsIdx) syntax structure that is directly included in the submesh header of the current submesh. When bmsps_num_ref_mesh_frame_lists_in_bmsps is equal to 0, the value of smh_ref_mesh_frame_list_bmsps_flag is inferred to be equal to 0.

smh_ref_mesh_frame_list_idx specifies the index, into the list of the bmesh_ref_list_struct(rlsIdx) syntax structures included in the active ASPS, of the bmesh_ref_list_struct(rlsIdx) syntax structure that is used for derivation of the reference mesh frame list for the current submesh. The syntax element smh_ref_mesh_frame_list_idx is represented by Ceil(Log 2(bmsps_num_ref_mesh_frame_lists_in_bmsps)) bits. When not present, the value of smh_ref_mesh_frame_list_idx is inferred to be equal to 0. The value of smh_ref_mesh_frame_list_idx shall be in the range of 0 to bmsps_num_ref_mesh_frame_lists_in_bmsps−1, inclusive. When smh_ref_mesh_frame_list_bmsps_flag is equal to 1 and bmsps_num_ref_mesh_frame_lists_in_bmsps is equal to 1, the value of smh_ref_mesh_frame_list_idx is inferred to be equal to 0.

The variable RlsIdx for the current atlas tile is derived as follows:

```
RlsIdx = smh_ref_mesh_frame_list_bmsps_flag ?
  smh_ref_mesh_frame_list_idx :
  bmsps_num_ref_mesh_frame_lists_in_bmsps
```

smh_additional_mfoc_lsb_present_flag[j] equal to 1 specifies that smh_additional_mfoc_lsb_val[j] is present for the current submesh. smh_additional_mfoc_lsb_present_flag[j] equal to 0 specifies that smh_additional_mfoc_lsb_val[j] is not present.

smh_additional_mfoc_lsb_val[j] specifies the value of FullMeshFrmOrderCntLsbLt[RlsIdx][j] for the current atlas tile as follows:

FullMeshFrmOrderCntLsbLt[ RlsIdx ][ j ] =
smh_additional_mfoc_lsb_val[ j ] * MaxMeshFrmOrderCntLsb
+mfoc_lsb_lt[ RlsIdx ][ j ]

The syntax element smh_additional_mfoc_lsb_val[j] is represented by smh_additional_lt_mfoc_lsb_len bits. When not present, the value of smh_additional_mfoc_lsb_val[j] is inferred to be equal to 0.

smh_num_ref_idx_active_override_flag equal to 1 specifies that the syntax element smh_num_ref_idx_active_minus1 is present for the current submesh. smh_num_ref_idx_active_override_flag equal to 0 specifies that the syntax element smh_num_ref_idx_active_minus1 is not present. If smh_num_ref_idx_active_override_flag is not present, its value shall be inferred to be equal to 0.

smh_num_ref_idx_active_minus1 is used for the derivation of the variable NumRefIdxActive as specified by Equation 5 for the current submesh. The value of smh_num_ref_idx_active_minus1 shall be in the range of 0 to 14, inclusive.

When the current submesh is a P_SUBMESH submesh, smh_num_ref_idx_active_override_flag is equal to 1, and smh_num_ref_idx_active_minus1 is not present, smh_num_ref_idx_active_minus1 is inferred to be equal to 0.

The variable NumRefIdxActive is derived as follows:

if( smh_type == P_SUBMESH ∥ smh_type == SKIP_SUBMESH ) {
if( smh_num_ref_idx_active_override_flag == 1 )

| | |
|---|---|
| NumRefIdxActive = smh_num_ref_idx_active_minus1 + 1 | (5) |

```
  else {
    if( num_ref_entries[ RlsIdx ] >= bfps_num_ref_idx_default_active_minus1 + 1 )
      NumRefIdxActive = bfps_num_ref_idx_default_active_minus1 + 1
    else
      NumRefIdxActive = num_ref_entries[ RlsIdx ]
  }
}
else
  NumRefIdxActive = 0
```

NumRefIdxActive minus 1 specifies the maximum value of the atlas reference frame index that may be used to decode the current atlas tile.

### H.8.3.5 Reference List Structure Semantics

num_ref_entries[rlsIdx] specifies the number of entries in the bmesh_ref_list_struct(rlsIdx) syntax structure, where rlsIdx is the index of an mesh frame reference list. For P_SUBMESH and SKIP_SUBMESH, the value of num_ref_entries[rlsIdx] shall be in the range of 1 to bmsps_max_dec_mesh_frame_buffering_minus1+1. Otherwise, the value of num_ref_entries[rlsIdx] shall be in the range of 0 to bmsps_max_dec_mesh_frame_buffering_minus1+1.

st_ref_mesh_frame_flag[rlsIdx][i] equal to 1 specifies that the i-th entry in the bmesh_ref_list_struct(rlsIdx) syntax structure is a short term reference mesh frame entry. st_ref_mesh_frame_flag[rlsIdx][i] equal to 0 specifies that the i-th entry in the ref_list_struct(rlsIdx) syntax structure is a long term reference mesh frame entry. When not present, the value of st_ref_mesh_frame_flag[rlsIdx][i] is inferred to be equal to 1.

The variable NumLtrMeshFrmEntries[rlsIdx] is derived as follows:

| NumLtrMeshFrmEntries[ rlsIdx ] = 0 | |
|---|---|
| for( i = 0; i < num_ref_entries[ rlsIdx ]; i++ ) | |
| if( !st_ref_mesh_frame_flag[ rlsIdx ][ i ] ) | (6) |

NumLtrMeshFrmEntries[ rlsIdx ]++

abs_delta_mfoc_st[rlsIdx][i], when the i-th entry is the first short term reference mesh frame entry in bmesh_ref_list_struct(rlsIdx) syntax structure, specifies the absolute difference between the mesh frame order count values of the current mesh tile and the mesh frame referred to by the i-th entry, or, when the i-th entry is a short term reference mesh frame entry but not the first short term reference mesh frame entry in the bmesh_ref_list_struct(rlsIdx) syntax structure, specifies the absolute difference between the mesh frame order count values of the mesh frames referred to by the i-th entry and by the previous short term reference mesh frame entry in the bmesh_ref_list_struct(rlsIdx) syntax structure.

The value of abs_delta_mfoc_st[rlsIdx][i] shall be in the range of 0 to 215−1, inclusive.

straf_entry_sign_flag[rlsIdx][i] equal to 1 specifies that the i-th entry in the syntax structure bmesh_ref_list_struct(rlsIdx) has a value greater than or equal to 0. straf_entry_sign_flag[rlsIdx][i] equal to 0 specifies that the i-th entry in the syntax structure bmesh_ref_list_struct(rlsIdx) has a value less than 0. When not present, the value of straf_entry_sign_flag[rlsIdx][i] is inferred to be equal to 1.

The list DeltaMfocSt[rlsIdx][i] is derived as follows:

```
for( i = 0; i < num_ref_entries[ rlsIdx ]; i++ )
  if( st_ref_mesh_frame_flag[ rlsIdx ][ i ] )
    DeltaMfocSt[ rlsIdx ][ i ] =
( 2 * straf_entry_sign_flag[ rlsIdx ][ i ] − 1 ) * abs_delta_mfoc_st[
rlsIdx ][ i ] (7)
  else
    DeltaMfocSt[ rlsIdx ][ i ] = 0
```

mfoc_lsb_lt[rlsIdx][i] specifies the value of the mesh frame order count modulo MaxMeshFrmOrderCntLsb of the mesh frame referred to by the i-th entry in the bmesh_ref_list_struct(rlsIdx) syntax structure. The length of the mfoc_lsb_lt[rlsIdx][i] syntax element is Log 2MaxMeshFrmOrderCntLsb bits.

### 2.10 Arithmetic Coding of Displacement Data

In an example working draft of dynamic mesh coding [3], displacement data can be coded using arithmetic coding. We refer the method to AC-based displacement coding. The following syntax table and semantics illustrate the design:

### J.7 Syntax and Semantics

### J.7.1 Syntax in Tabular Form

### J.7.1.1 General NAL Unit Syntax

| | Descriptor |
|---|---|
| displ_nal_unit( NumBytesInNalUnit ) { | |
| displ_nal_unit_header( ) | |
| NumBytesInRbsp = 0 | |
| for( i = 2; i < NumBytesInNalUnit; i++ ) | |
| rbsp_{—}byte[ NumBytesInRbsp++ ] | b(8) |
| } | |

### J.7.1.3 Raw Byte Sequence Payloads, Trailing Bits, and Byte Alignment Syntax

### J.7.1.3.1 Displacement Sequence Parameter Set RBSP Syntax

### J.7.1.3.1.1 General Displacement Sequence Parameter Set RBSP Syntax

| | De- |
|---|---|
| | scriptor |
| displ_sequence_parameter_set_rbsp( ) { | |
| dsps_sequence_parameter_set_id | u(4) |
| dsps_codec_id | u(8) |
| dsps_profile_tier_level( ) | |
| dsps_range_log2_minus2 | u(3) |
| dsps_single_dimension_flag | u(1) |
| dsps_msb_align_flag | u(1) |
| dsps_log2_max_displ_frame_order_cnt_lsb_minus4 | ue(v) |
| dsps_max_dec_displ_frame_buffering_minus1 | ue(v) |
| dsps_long_term_ref_displ_frames_flag | u(1) |
| dsps_num_ref_displ_frame_lists_in_dsps | ue(v) |
| for( i = 0; i < dsps_num_ref_displ_frame_lists_in_dsps; | |
| i++ ) | |
| displ_ref_list_struct( i ) | |
| dsps_extension_present_flag | u(1) |
| if( dsps_extension_present_flag ) { | |
| dsps_extension_count_minus1 | u(7) |
| dsps_extension_length_minus1 | ue(v) |
| while( more_rbsp_data( ) ) | |
| dsps_extension_data_byte | u(1) |
| } | |
| rbsp_trailing_bits( ) | |
| } | |

### J.7.1.3.1.2 Displacement Profile, Tier, and Level Syntax

| | Descriptor |
|---|---|
| dsps_profile_tier_level( ) { | |
| dptl_tier_flag | u(1) |
| dptl_profile_codec_group_idc | u(7) |
| dptl_profile_toolset_idc | u(8) |
| dptl_reserved_zero_32bits | u(32) |
| dptl_level_idc | u(8) |
| dptl_num_sub_profiles | u(6) |
| dptl_extended_sub_profile_flag | u(1) |
| for( i = 0; i < dptl_num_sub_profiles; i++ ) { | |
| dptl_sub_profile_idc[ i ] | u(v) |
| } | |
| dptl_toolset_constraints_present_flag | u(1) |
| if( dptl_toolset_constraints_present_flag ) { | |
| dptl_profile_toolset_constraints_information( ) | |
| } | |
| } | |

### J.7.1.3.1.3 Profile Toolset Constraints Information Syntax

| | Descriptor |
|---|---|
| dptl_profile_toolset_constraints_information( ) { | |
| dptc_one_displacement_frame_only_flag | u(1) |
| dptc_reserved_zero_7bits | u(6) |
| dptc_num_reserved_constraint_bytes | u(8) |
| for( i = 0; i < dptc_num_reserved_constraint_bytes; i++ ) | |
| dptc_reserved_constraint_byte[ i ] | u(8) |
| } | |

### J.7.1.3.2 Displacement Frame Parameter Set RBSP Syntax

### J.7.1.3.2.1 General Displacement Frame Parameter Set RBPS Syntax

| | Descriptor |
|---|---|
| displ_frame_parameter_set_rbsp( ) { | |
| dfps_displ_sequence_parameter_set_id | u(4) |
| dfps_displ_frame_parameter_set_id | u(4) |
| displ_information( ) | |
| dfps_output_flag_present_flag | u(1) |
| dfps_num_ref_idx_default_active_minus1 | ue(v) |
| dfps_additional_lt_dfoc_lsb_len | ue(v) |
| dfps_extension_present_flag | u(1) |
| if( dfps_extension_present_flag ) | |
| dfps_extension_8bits | u(8) |
| if( dfps_extension_8bits ) | |
| while( more_rbsp_data( ) ) | |
| dfps_extension_data_flag | u(1) |
| rbsp_trailing_bits( ) | |
| } | |

### J.7.1.3.3 Displacement Reference List Structure Syntax

| | Descriptor |
|---|---|
| displ_ref_list_struct( rlsIdx ) { | |
| drl_num_ref_entries[ rlsIdx ] | ue(v) |
| for( i = 0; i < drl_num_ref_entries[ rlsIdx ]; i++ ) { | |
| if( dsps_long_term_ref_displ_frames_flag ) | |
| drl_st_ref_displ_frame_flag[ rlsIdx ][ i ] | u(1) |
| if( drl_st_ref_displ_frame_flag[ rlsIdx ][ i ] ) { | |
| drl_abs_delta_dfoc_st[ rlsIdx ][ i ] | ue(v) |
| if( drl_abs_delta_dfoc_st[ rlsIdx ][ i ] > 0 ) | |
| drl_straf_entry_sign_flag[ rlsIdx ][ i ] | u(1) |
| } else | |
| drl_dfoc_lsb_lt[ rlsIdx ][ i ] | u(v) |
| } | |
| } | |

### J.7.1.3.5 Displacement Header Syntax

Descriptor

```
displ_layer_rbsp( ) {
  displ_header( )
  displ_data_unit( dfh_displ_type , DisplUnitSize )
  rbsp_trailing_bits( )
}
```

| | Descriptor |
|---|---|
| displ_header( ) { | |
| if( nal_unit_type >= NAL_BLA_W_LP && nal_unit_type <= NAL_RSV_IRAP_DCL_{—} | |
| 29 ) | |
| no_output_of_prior_displ_frames_flag | u(1) |
| displ_frame_parameter_set_id | u(4) |
| displ_id | u(v) |
| displID = displ_id | |
| displ_type | ue(v) |
| if( dfps_output_flag_present_flag ) | |
| displ_output_flag | u(1) |
| displ_frm_order_cnt_lsb | u(v) |
| if( dsps_num_ref_displ_frame_lists_in_dsps > 0 ) | |
| ref_displ_frame_list_dsps_flag | u(1) |
| if( ref_displ_frame_list_dsps_flag == 0 ) | |
| displ_ref_list_struct( dsps_num_ref_displ_frame_lists_in_dsps ) | |
| else if( dsps_num_ref_displ_frame_lists_in_dsps > 1 ) | |
| ref_displ_frame_list_idx | u(v) |
| for(j = 0; j < NumLtrDisplFrmEntries[ RlsIdx ]; j++ ) { | |
| additional_dfoc_lsb_present_flag[ j ] | u(1) |
| if( additional_dfoc_lsb_present_flag[ j ] ) | |
| additional_dfoc_lsb_val[ j ] | u(v) |
| } | |
| if( smh_type == P_DISPLACEMENT && num_ref_entries[ RlsIdx ] > 1 ) { | |
| num_ref_idx_active_override_flag | u(1) |
| if( num_ref_idx_active_override_flag ) | |
| num_ref_idx_active_minus1 | ue(v) |
| } | |
| subblock_size | u(16) |
| byte_alignment( ) | |
| } | |

### J.7.1.3.6 Displacement Data Unit Syntax

Descriptor

```
displ_data_unit( displID , unitSize) {
  if( displ_type == I_DISPLACEMENT ) {
    displ_intra_unit( unitSize )
  }
  else if( displ_type == P_DISPLACEMENT ) {
    displ_inter_unit( unitSize )
  }
}
```

### J.7.1.3.7 Displacement Intra Data Unit Syntax

| | Descriptor |
|---|---|
| displ_intra_unit( unitSize, lodCount, subblock_size, vertexCount ) { | |
| for( k = 0; k < 3; k++ ) { | |
| diu_last_sig_coeff[ k ] | ae(v) |
| for( b = 0; b < lodCount; b++ ) { | |
| diu_coded_block_flag[ k ][ b ] | u(v) |
| if( diu_coded_block_flag[ i ][ j ] ) { | |
| for( s = 0; s < vertexCount[ b ] % subblock_size; s++ ) { | |
| diu_coded_subblock_flag[ k ][ b ][ s ] | u(v) |
| if( diu_coded_subblock_flag[ k ][ b ][ s ] ) { | |
| for( v = vStart; v < subblock_size; v++ ) { | |
| diu_coeff_abs_level_gt0[ k ][ b ][ s ][ v ] | u(v) |
| if( diu_coeff_abs_level_gt0[ k ][ b ][ s ][ v ] ) { | |
| diu_coeff_abs_level_gt1[ k ][ b ][ s ][ v ] | u(v) |
| diu_coeff_sign[ k ][ b ][ s ][ v ] | u(1) |
| if( diu_coeff_abs_level_gt1[ k ][ b ][ s ][ v ] ) { | |
| diu_coeff_abs_level_rem[ k ][ b ][ s ][ v ] | ue(v) |
| } | |
| } | |
| } | |
| } | |
| } | |
| } | |
| } | |
| if ( dsps_single_dimension_flag ) { | |
| break; | |
| } | |
| } | |
| } | |

### J.7.1.3.8 Displacement Inter Data Unit Syntax

Descriptor

displ_inter_unit( unitSize, lodCount, subblock_size,
vertexCount ) {
Same as A.7.1.3.7
}

### J.7.2 Semantics

### J.7.2.1 NAL Unit Semantics

### J.7.2.1.1 General NAL Unit Semantics

NumBytesInNalUnit specifies the size of the NAL unit in bytes. This value is required for decoding of the NAL unit. Some form of demarcation of NAL unit boundaries is necessary to enable inference of NumBytesInNalUnit. One such demarcation method is specified for the sample stream format. Other methods of demarcation can be specified outside this document.

NOTE 1—The displacement coding layer (DCL) is specified to efficiently represent the content of the displacement data. The NAL is specified to format that data and provide header information in a manner appropriate for conveyance on a variety of communication channels or storage media. All data are contained in NAL units, each of which contains an integer number of bytes. A NAL unit specifies a generic format for use in both packet-oriented and bitstream systems. The format of NAL units for both packet-oriented transport and sample streams is identical except that in the sample stream format specified in Annex TBD each NAL unit can be preceded by an additional element that specifies the size of the NAL unit.

rbsp_byte[i] is the i-th byte of an RBSP. An RBSP is specified as an ordered sequence of bytes as follows:

The RBSP contains a string of data bits (SODB) as follows:
If the SODB is empty (i.e., zero bits in length), the RBSP is also empty.
Otherwise, the RBSP contains the SODB as follows:
   1) The first byte of the RBSP contains the first (most significant, left-most) eight bits of the SODB; the next byte of the RBSP contains the next eight bits of the SODB, etc., until fewer than eight bits of the SODB remain.
   2) The rbsp_trailing_bits( ) syntax structure is present after the SODB as follows:
      i) The first (most significant, left-most) bits of the final RBSP byte contain the remaining bits of the SODB (if any).
      ii) The next bit consists of a single bit equal to 1 (i.e., rbsp_stop_one_bit).
      iii) When the rbsp_stop_one_bit is not the last bit of a byte-aligned byte, one or more bits equal to 0 (i.e. instances of rbsp_alignment_zero_bit) are present to result in byte alignment.

Syntax structures having these RBSP properties are denoted in the syntax tables using an “_rbsp” suffix. These structures are carried within NAL units as the content of the rbsp_byte[i] data bytes. The association of the RBSP syntax structures to the NAL units is as specified below.

NOTE 2—When the boundaries of the RBSP are known, the decoder can extract the SODB from the RBSP by concatenating the bits of the bytes of the RBSP and discarding the rbsp_stop_one_bit, which is the last (least significant, right-most) bit equal to 1, and discarding any following (less significant, farther to the right) bits that follow it, which are equal to 0. The data necessary for the decoding process is contained in the SODB part of the RBSP.

### J.7.2.1.2 NAL Unit Header Semantics

Similar NAL unit types, as for the atlas case, were defined for the displacement enabling similar functionalities for random access define specific nal units that correspond to coded displacement data. In addition, NAL units that can include metadata such as SEI messages are also defined.

In particular, the displacement NAL unit types supported are specified as follows:

| | | | NAL |
|---|---|---|---|
| | | Content of displacement NAL unit and | unitype |
| displ_nal_unit_type | Name of displ_nal_unit_type | RBSP syntax structure | class |
| 0 | NAL_TRAIL_N | Coded displacement of a non-TSA, non | DCL |
| 1 | NAL_TRAIL_R | STSA trailing displacement frame | |
| | | displ_layer_rbsp( ) | |
| 2 | NAL_TSA_N | Coded displacement of a TSA | DCL |
| 3 | NAL_TSA_R | displacement frame | |
| | | displ_layer_rbsp( ) | |
| 4 | NAL_STSA_N | Coded displacement of a STSA | DCL |
| 5 | NAL_STSA_R | displacement frame | |
| | | displ_layer_rbsp( ) | |
| 6 | NAL_RADL_N | Coded displacement of a RADL | DCL |
| 7 | NAL_RADL_R | displacement frame | |
| | | displ_layer_rbsp( ) | |
| 8 | NAL_RASL_N | Coded displacement of a RASL | DCL |
| 9 | NAL_RASL_R | displacement frame | |
| | | displ_layer_rbsp( ) | |
| 10 | NAL_SKIP_N | Coded displacement of a skipped | DCL |
| 11 | NAL_SKIP_R | displacement frame | |
| | | displ_layer_rbsp( ) | |
| 12 | NAL_RSV_DCL_N12 | Reserved non-IRAP sub-layer non- | DCL |
| 14 | NAL_RSV_DCL_N14 | reference DCL displacement NAL unit | |
| | | types | |
| 13 | NAL_RSV_DCL_R13 | Reserved non-IRAP sub-layer reference | DCL |
| 15 | NAL_RSV_DCL_R15 | DCL displacement NAL unit types | |
| 16 | NAL_BLA_W_LP | Coded displacement of a BLA | DCL |
| 17 | NAL_BLA_W_RADL | displacement frame | |
| 18 | NAL_BLA_N_LP | displ_layer_rbsp( ) | |
| 19 | NAL_IDR_W_RADL | Coded displacement of an IDR | DCL |
| 20 | NAL_IDR_N_LP | displacement frame | |
| | | displ_layer_rbsp( ) | |
| 21 | NAL_CRA | Coded displacement of a CRA | DCL |
| | | displacement frame | |
| | | displ_layer_rbsp( ) | |
| 22 | NAL_RSV_IRAP_DCL_22 | Reserved IRAP DCL NAL unit types | DCL |
| 23 | NAL_RSV_IRAP_DCL_23 | | |
| 24 . . . 29 | NAL_RSV_DCL_24 . . . | Reserved non-IRAP DCL NAL unit types | DCL |
| | NAL_RSV_DCL_29 | | |
| 30 | NAL_DSPS | Displacement sequence parameter set | non- |
| | | displ_sequence_parameter_set_rbsp( ) | DCL |
| 31 | NAL_DFPS | Displacement frame parameter set | non- |
| | | displ_frame_parameter_set_rbsp( ) | DCL |
| 32 | NAL_DAUD | Access unit delimiter | non- |
| | | access_unit_delimiter_rbsp( ) | DCL |
| 33 | NAL_DEOS | End of sequence | non- |
| | | end_of_sequence_rbsp( ) | DCL |
| 34 | NAL_DEOB | End of bitstream | non- |
| | | end_of_displ_sub_bitstream_rbsp( ) | DCL |
| 35 | NAL_FD | Filler | non- |
| | | filler_data_rbsp( ) | DCL |
| 36 | NAL_PREFIX_NSEI | Non-essential supplemental enhancement | non- |
| 37 | NAL_SUFFIX_NSEI | information | DCL |
| | | sei_rbsp( ) | |
| 38 | NAL_PREFIX_ESEI | Essential supplemental enhancement | non- |
| 39 | NAL_SUFFIX_ESEI | information | DCL |
| | | sei_rbsp( ) | |
| 40 . . . 44 | NAL_RSV_NDCL_40 | Reserved non-DCL NAL unit types | non- |
| | NAL_RSV_NDCL_44 | | DCL |
| 45 . . . 63 | NAL_UNSPEC_45 | Unspecified non-DCL NAL unit types | non- |
| | NAL_UNSPEC_63 | | DCL |

### J.7.2.1.3 Order of NAL Units and Displacement Frames, and Association to Coded Displacement Frames, Access Units, and Coded Displacement Sequences

### J.7.3 Raw Byte Sequence Payloads, Trailing Bits, and Byte Alignment Semantics

### J.7.3.1 Displacement Sequence Parameter Set RBSP Semantics

### J.7.3.1.1 General Displacement Sequence Parameter Set RBSP Semantics

dsps_sequence_pamameter_set_id provides an identifier for the displacement sequence parameter set for reference by other syntax elements.

dsps_codec_id indicates the identifier of the codec used to compress the displacement. dsps_codec_id shall be in the range of 0 to 255, inclusive. This codec may be identified through the profiles defined herein, a component codec mapping SEI message, or through means outside this document. It may be associated with a specific displacement codec through the profiles specified in the corresponding specification, or could be explicitly indicated with an SEI message as is done in the V3C specification for the video sub-bitstreams.

dsps_range_log 2_minus2 plus 2 indicates the range of the geometry displacement coordinates of the displacements. dsps_range_log 2_minus2 shall be in the range of 0 to 3, inclusive.

dsps_single_dimension_flag indicates the number of dimensions for the displacements associated with the displacements. dsps_single_dimension_flag equal to 0 indicates three components for the displacements are used. dsps_single_dimension_flag equal to 1 indicates only normal component for the displacements is used.

dsps_msb_align_flag indicates how the decoded displacement samples are converted to samples at the displacement range bit depth.

dsps_log 2_max_displ_frame_order_cnt_lsb_minus4 plus 4 specifies the values of the variables Log 2MaxDisplFrmOrderCntLsb and MaxDisplFrmOrderCntLsb that are used in the decoding process for the displacement frame order count as follows:

$$Log 2 Max DisplFrmOrderCntLsb = dsps\_log2 \_max \_displ \_frame \_order \_cnt \_lsb \_minus4 + 4 \qquad ( 2 )$$

$$Max DisplFrmOrderCntLsb = {2}^{Log 2 MaxDisplFrmOrderCntLsb} \qquad ( 3 )$$

The value of dsps_log 2_max_displ_frame_order_cnt_lsb_minus4 shall be in the range of 0 to 12, inclusive.

dsps_max_dec_displ_frame_buffering_minus1 plus 1 specifies the maximum required size of the decoded displacement frame buffer for the CDS in units of displacement frame storage buffers. The value of dsps_max_dec_displ_frame_buffering_minus1 shall be in the range of 0 to 15, inclusive.

dsps_long_term_ref_displ_frames_flag equal to 0 specifies that no long-term reference displacement is used for inter prediction of any coded displacement frame in the CDS. dsps_long_term_ref_displ_frames_flag equal to 1 specifies that long term reference displacement frames may be used for inter prediction of one or more coded displacement frames in the CDS.

dsps_num_ref_displ_frame_lists_in_dsps specifies the number of the displ_ref_list_struct(rlsIdx) syntax structures included in the displacement sequence parameter set. The value of dsps_num_ref_displ_frame_lists_in_dsps shall be in the range of 0 to 64, inclusive.

NOTE 1—A decoder allocates memory for a total number of displ_ref_list_struct(rlsIdx) syntax structures equal to (dsps_num_ref_displ_frame_lists_in_dsps+1) since there can be one displ_ref_list_struct(rlsIdx) syntax structure directly signalled in the displacement headers of the current displacement frame.

dsps_extension_present_flag equal to 1 specifies that dsps_extension_count_minus1 and dsps_extension_length_minus1 are present in the displacement sequence parameter set.

dsps_extension_count_minus1 plus 1 specifies the number of extensions present in the current displacement sequence parameter set. When not present, dsps_extension_count_minus1 is inferred to be equal to −1.

dsps_extension_length_minus1 plus 1 specifies the length of dsps_extension_data_byte elements that follow this syntax element. When not present, dsps_extension_length_minus1 is inferred to be equal to −1.

dsps_extension_data_byte may have any value.

### J.7.3.1.2 Displacement Profile, Tier, and Level Semantics

dptl_tier_flag specifies the tier context for the interpretation of dptl_level_idc.

dptl_profile_codec_group_idc indicates the codec group profile component to which the CDS conforms. Bitstreams shall not contain values of dptl_profile_codec_group_idc other than those specified in herein. Other values of dptl_profile_codec_group_idc are reserved for future use by ISO/JEC.

dptl_profile_toolset_idc indicates the toolset combination profile component to which the CDS conforms. Bitstreams shall not contain values of dptl_profile_toolset_idc other than those specified in herein. Other values of dptl_profile_toolset_idc are reserved for future use by ISO/JEC.

dptl_profile_reconstruction_idc indicates the reconstruction profile component to which the CDS is recommended to conform. Decoders may select to use a different reconstruction profile than the one indicated in the bitstream. Bitstreams shall not contain values of dptl_profile_reconstruction_idc other than those specified herein. Other values of dptl_profile_reconstruction_idc are reserved for future use by ISO/IEC.

dptl_reserved_zero_16bits, when present, shall be equal to 0 in bitstreams conforming to this version of this document. Other values for dptl_reserved_zero_16bits are reserved for future use by ISO/JEC. Decoders shall ignore the value of dptl_reserved_zero_16bits.

dptl_reserved_0xffff_16bits, when present, shall be equal to 0xFFFF in bitstreams conforming to this version of this document. Other values for dptl_reserved_0xffff_16bits are reserved for future use by ISO/JEC. Decoders shall ignore the value of dptl_reserved_0xffff_16bits.

dptl_level_idc indicates a level to which the CDS conforms. Bitstreams shall not contain values of dptl_level_idc other than those specified in herein. Other values of dptl_level_idc are reserved for future use by ISO/IEC.

dptl_num_sub_profiles indicates the number of the dptl_sub_profile_idc[i] syntax elements.

dptl_extended_sub_profile_flag equal to 1 specifies that the dptl_sub_profile_idc[i] syntax elements, if present, should be represented using 64 bits. dptl_extended_sub_profile_flag equal to 0 specifies that the dptl_sub_profile_idc[i] syntax elements, if present, should be represented using 32 bits.

dptl_sub_profile_idc[i] indicates the i-th interoperability metadata registered as specified by Rec. ITU-T T.35, the content of which is not specified in this document. The number of bits used to represent dptl_sub_profile_idc[i] is equal to (dptl_extended_sub_profile_flag==0?32:64).

dptl_toolset_constraints_present_flag equal to 1 specifies that an additional structure, dptl_profile_toolset_constraints_information( ), is present in the bitstream. dptl_toolset_constraints_present_flag equal to 0 specifies that the structure dptl_profile_toolset_constraints_information( ) is not present.

### J.7.3.1.3 Displacement Profile Toolset Constraints Information Semantics

dptc_one_displacemnt_frame_only_flag, when present, has semantics specified herein where the profile indicated by dptl_profile_toolset_idc is a profile specified herein. When not present, dptc_one_displacement_frame_only_flag is inferred to be equal to 0.

dptc_reserved_zero_7bits shall be equal to 0 in bitstreams conforming to this version of this document. Other values of dptc_reserved_zero_7bits are reserved for future use by ISO/IEC and shall not be present in bitstreams conforming to this version of this document. Decoders conforming to this version of this document shall ignore values of dptc_reserved_zero_7bits other than 0.

dptc_num_reserved_constraint_bytes specifies the number of the reserved constraint bytes. The value of dptc_num_reserved_constraint_bytes shall be 0 in bitstreams conforming to this version of this document. Other values of dptc_num_reserved_constraint_bytes are reserved for future use by ISO/IEC and shall not be present in bitstreams conforming to this version of this document. Decoders conforming to this version of this document shall ignore values of dptc_num_reserved_constraint_bytes other than 0.

dptc_reserved_constraint_byte[i] may have any value. Its presence and value do not affect decoder conformance to profiles specified in this version of this document. Decoders conforming to this version of this document shall ignore the values of all the dptc_reserved_constraint_byte[i] syntax elements.

### J.7.3.2 Displacement Frame Parameter Set RBSP Semantics

### J.7.3.2.1 General Displacement Frame Parameter Set RBSP Semantics

dfps_displ_sequence_parameter_set_id specifies the value of dsps_sequence_parameter_set_id for the active displacement sequence parameter set.

dfps_displ_parameter_set_id identifies the displacement frame parameter set for reference by other syntax elements.

dfps_output_flag_present_flag equal to 1 indicates that the displ_output_flag syntax element is present in the associated displacement headers. dfps_output_flag_present_flag equal to 0 indicates that the displ_output_flag syntax element is not present in the associated displacement headers.

dfps_num_ref_idx_default_active_minus1 plus 1 specifies the inferred value of the variable NumRefIdxActive for the tile with displ_num_ref_idx_active_override_flag equal to 0. The value of dfps_num_ref_idx_default_active_minus1 shall be in the range of 0 to 14, inclusive.

dfps_additional_lt_dfoc_lsb_len specifies the value of the variable MaxLtDisplFrmOrderCntLsb that is used in the decoding process for reference atlas frame lists as follows:

$$Max LtDisplFrmOrderCntLsb = 2 * ( Log 2 Max DisplFrmOrderCntLsb + dfps\_additional \_lt \_dfoc \_lsb \_len ) \qquad ( 4 )$$

The value of dfps_additional_lt_dfoc_lsb_len shall be in the range of 0 to 32−Log 2MaxDisplFrmOrderCntLsb, inclusive.

When dsps_long_term_ref_displ_frames_flag is equal to 0, the value of dfps_additional_lt_dfoc_lsb_len shall be equal to 0.

dfps_extension_present_flag equal to 1 specifies that the syntax element dfps_extension_8bits is present in the displacement frame parameter set. dfps_extension_present_flag equal to 0 specifies that the syntax element dfps_extension_8bits is not present. The value of dfps_extension_present_flag shall be 0 in this version of this document

dfps_extension_8bits equal to 0 specifies that no dfps_extension_data_flag syntax elements are present in the DFPS RBSP syntax structure. When present, dfps_extension_8bits shall be equal to 0 in bitstreams conforming to this version of this document. Values of dfps_extension_8bits not equal to 0 are reserved for future use by ISO/IEC. Decoders shall allow the value of dfps_extension_8bits to be not equal to 0 and shall ignore all dfps_extension_data_flag syntax elements in an DFPS NAL unit. When not present, the value of dfps_extension_8bits is inferred to be equal to 0.

dfps_extension_data_flag may have any value. Its presence and value do not affect decoder conformance to profiles specified in this version of this document. Decoders conforming to this version of this document shall ignore all dfps_extension_data_flag syntax elements.

displ_no_output_of_prior_displ_frames_flag affects the output of previously-decoded displacement frames in the DDB after the decoding of a displacement frame in a CDS AU that is not the first AU in the bitstream. When no_output_of_prior_displ_frames_flag is not present, its value is inferred to be equal to 0.

It is a requirement of bitstream conformance that the value of no_output_of_prior_displ_frames_flag shall be the same for all displacement frames in an AU.

The value of no_output_of_priordispl_frames_flag in the displacement headers is also referred to as the output_of_prior_displ_frames_flag value of the AU.

displ_frame_parameter_set_id specifies the value of dfps_displ_frame_parameter_set_id for the active displacement frame parameter set for the current displacement frame.

dislp_type specifies the coding type of the current displacement frame according to Table 10. The value of smh_type shall be equal to 0, 1, or 2 in bitstreams conforming to this version of this document. Other values of smh_type are reserved for future use by ISO/JEC. Decoders conforming to this version of this document shall ignore reserved values of smh_type.

TABLE 10
Name association to dislp_type

| smh_type | Name of smh_type |
|---|---|
| 0 | P_DISPLACEMENT |
| 1 | I_DISPLACEMENT |
| 2- . . . | RESERVED |

displ_output_flag affects the decoded displacement output and removal processes. When displ_output_flag is not present, it is inferred to be equal to 1.

displ_frm_order_cnt_lsb specifies the displacement frame order count modulo MaxDisplFrmOrderCntLsb for the current displacement frame. The length of the displ_frm_order_cnt_lsb syntax element is equal to Log 2MaxDisplFrmOrderCntLsb bits. The value of the displ_frm_order_cnt_lsb shall be in the range of 0 to MaxDisplFrmOrderCntLsb−1, inclusive.

ref_displ_frame_list_dsps_flag equal to 1 specifies that the reference displacement frame list of the current displacement frame is derived based on one of the displ_ref_list_struct(rlsIdx) syntax structures in the active DSPS. ref_displ_frame_list_dsps_flag equal to 0 specifies that the reference displacement frame list of the current displacement frame is derived based on the displ_ref_list_struct(rlsIdx) syntax structure that is directly included in the displacement frame header of the current displacement frame. When dsps_num_ref_displ_frame_lists_in_dsps is equal to 0, the value of ref_displ_frame_list_dsps_flag is inferred to be equal to 0.

ref_displ_frame_list_idx specifies the index, into the list of the displ_ref_list_struct(rlsIdx) syntax structures included in the active DSPS, of the displ_ref_list_struct(rlsIdx) syntax structure that is used for derivation of the reference displacement frame list for the current displacement frame. The syntax element ref_displ_frame_list_idx is represented by Ceil(Log 2(dsps_num_ref_displ_frame_lists_in_dsps)) bits. When not present, the value of ref_displ_frame_list_idx is inferred to be equal to 0. The value of ref_displ_frame_list_idx shall be in the range of 0 to dsps_num_ref_displ_frame_lists_in_dsps−1, inclusive. When ref_displ_frame_list_dsps_flag is equal to 1 and dsps_num_ref_displ_frame_lists_in_dsps is equal to 1, the value of ref_displ_frame_list_idx is inferred to be equal to 0.

The variable RlsIdx for the current atlas tile is derived as follows:

$$RlsIdx = ref\_displ \_frame \_list \_dsps \_flag ? ref\_displ \text{} \_frame \_ list\_idx : dsps\_num \_ref \_displ \_frame \_lists \_in \_dsps$$

additional_dfoc_lsb_present_flag[j] equal to 1 specifies that additional_dfoc_lsb_val[j] is present for the current displacement frame. additional_dfoc_lsb_present_flag[j] equal to 0 specifies that additional_dfoc_lsb_val[j] is not present.

additional_dfoc_lsb_val[j] specifies the value of FullFrmOrderCntLsbLt[RlsIdx][j] for the current atlas tile as follows:

$$FullDisplFrmOrderCntLsbLt [ RlsIdx ] [ j ] = additional\_dfoc \_lsb \_val [ j ] * Max DisplFrmOrder + dfoc\_lsb \_lt [ RlsIdx ] [ j ]$$

The syntax element additional_dfoc_lsb_val[j] is represented by dfps_additional_lt_dfoc_lsb_len bits. When not present, the value of additional_dfoc_lsb_val[j] is inferred to be equal to 0.

num_ref_idx_active_override_flag equal to 1 specifies that the syntax element num_ref_idx_active_minus1 is present for the current displacement frame. num_ref_idx_active_override_flag equal to 0 specifies that the syntax element num_ref_idx_active_minus1 is not present. If num_ref_idx_active_override_flag is not present, its value shall be inferred to be equal to 0.

num_ref_idx_active_minus1 is used for the derivation of the variable NumRefIdxActive as specified by Equation 5 for the current displacement frame. The value of num_ref_idx_active_minus1 shall be in the range of 0 to 14, inclusive.

When the current displacement frame is a P_DISPLACEMENT displacement frame, num_ref_idx_active_override_flag is equal to 1, and num_ref_idx_active_minus1 is not present, num_ref_idx_active_minus1 is inferred to be equal to 0.

The variable NumRefIdxActive is derived as follows:

```
if( displ_type == P_DISPLACEMENT ) {
  if( num_ref_idx_active_override_flag == 1 )
    NumRefIdxActive = num_ref_idx_active_minus1 + 1 (5)
  else {
    if( num_ref_entries[ RlsIdx ] >= dfps_num_ref_idx_default_active_minus1 + 1 )
      NumRefIdxActive = dfps_num_ref_idx_default_active_minus1 + 1
    else
      NumRefIdxActive = num_ref_entries[ RlsIdx ]
  }
}
else
  NumRefIdxActive = 0
```

NumRefIdxActive minus 1 specifies the maximum value of the displacement reference frame index that may be used to decode the current displacement frame.

### J.7.3.3 Reference List Structure Semantics

drl_num_ref_entries[rlsIdx] specifies the number of entries in the displ_ref_list_struct(rlsIdx) syntax structure, where rlsIdx is the index of a displacement frame reference list. For P_DISPLACEMENT, the value of num_ref_entries[rlsIdx] shall be in the range of 1 to dsps_max_dec_displ_frame_buffering_minus1+1. Otherwise, the value of num_ref_entries[rlsIdx] shall be in the range of 0 to dsps_max_dec_displ_frame_buffering_minus1+1.

drl_st_ref_displ_frame_flag[rlsIdx][i] equal to 1 specifies that the i-th entry in the displ_ref_list_struct(rlsIdx) syntax structure is a short term reference displacement frame entry. st_ref_displ_frame_flag[rlsIdx][i] equal to 0 specifies that the i-th entry in the displ_ref_list_struct(rlsIdx) syntax structure is a long term reference displacement frame entry. When not present, the value of drl_st_ref_displ_frame_flag[rlsIdx][i] is inferred to be equal to 1.

The variable NumLtrDisplFrmEntries[rlsIdx] is derived as follows:

```
NumLtrDisplFrmEntries[ rlsIdx ] = 0
for( i = 0; i < drl_num_ref_entries[ rlsIdx ]; i++ )
  if( !drl_st_ref_displ_frame_flag[ rlsIdx ][ i ] ) (6)
    NumLtrDisplFrmEntries[ rlsIdx ]++
```

drl_abs_delta_dfoc_st[rlsIdx][i], when the i-th entry is the first short term reference displacement frame entry in displ_ref_list_struct(rlsIdx) syntax structure, specifies the absolute difference between the displacement frame order count values of the current displacement frame referred to by the i-th entry, or, when the i-th entry is a short term reference displacement frame entry but not the first short term reference displacement frame entry in the displ_ref_list_struct(rlsIdx) syntax structure, specifies the absolute difference between the displacement frame order count values of the displacement frames referred to by the i-th entry and by the previous short term reference displacement frame entry in the displ_ref_list_struct(rlsIdx) syntax structure.

The value of drl_abs_delta_dfoc_st[rlsIdx][i] shall be in the range of 0 to 2¹⁵−1, inclusive.

drl_straf_entry_sign_flag[rlsIdx][i] equal to 1 specifies that the i-th entry in the syntax structure displ_ref_list_struct(rlsIdx) has a value greater than or equal to 0. drl_straf_entry_sign_flag[rlsIdx][i] equal to 0 specifies that the i-th entry in the syntax structure displ_ref_list_struct(rlsIdx) has a value less than 0. When not present, the value of drl_straf_entry_sign_flag[rlsIdx][i] is inferred to be equal to 1.

The list DeltaDfocSt[rlsIdx][i] is derived as follows:

```
  for( i = 0; i < drl_num_ref_entries[ rlsIdx ]; i++ )
    if( drl_st_ref_displ_frame_flag[ rlsIdx ][ i ] )
      DeltaDfocSt[ rlsIdx ][ i ] =
        ( 2 * drl_straf_entry_sign_flag[ rlsIdx ][ i ] − 1 ) *
drl_abs_delta_dfoc_st[ rlsIdx ][ i ] (7)
    else
      DeltaDfocSt[ rlsIdx ][ i ] = 0
```

drl_dfoc_lsb_lt[rlsIdx][i] specifies the value of the displacement frame order count modulo MaxDisplFrmOrderCntLsb of the displacement frame referred to by the i-th entry in the displ_ref_list_struct(rlsIdx) syntax structure. The length of the drl_dfoc_lsb_lt[rlsIdx][i] syntax element is Log 2MaxDisplFrmOrderCntLsb bits.

### J.7.3.4 Displacement Data Unit Semantics

displ_intra_unit(unitSize) contains a displacement unit stream of size unitSize, in bytes, as an ordered stream of bytes or bits within which the locations of unit boundaries are identifiable from patterns in the data. The format of such displacement unit stream is identified by a 4CC code as defined by dptl_profile_codec_group_idc or by a component codec mapping SEI message.

displ_inter_unit(unitSize) contains a displacement unit stream of size unitSize, in bytes, as an ordered stream of bytes or bits within which the locations of unit boundaries are identifiable from patterns in the data. The format of such displacement unit stream is identified by a 4CC code as defined by dptl_profile_codec_group_idc or by a component codec mapping SEI message.

### J.7.3.5 Displacement Intra Data Unit Semantics

The arithmetic decoding engine is a context-separated, binary arithmetic decoder, performing binary renormalization and producing binary outputs.

The displacement values are derived from the arithmetic decoding.

diu_last_sig_coeff[k] indicates the index of the last position of the nonzero displacement coefficient level in the k-th components.

diu_coded_block_flag[k][b] indicates whether the block with index b has any nonzero displacement coefficient levels in the k-th components (when 1), or not (when 0).

diu_coded_subblock_flag[k][b][s] indicates whether the subblock with index s of the block with index b has any nonzero displacement coefficient levels in the k-th components (when 1), or not (when 0).

diu_coeff_abs_level_gt0[k][b][s][v] indicates whether the k-th component of the displacement coefficient level associated with the vertex with index v of the subblock with index s of the block with index b has an absolute value higher than zero (when 1), or not (when 0).

diu_coeff_abs_level_gtl[k][b][s][v] indicates whether the k-th component of the displacement coefficient level associated with the vertex with index v of the subblock with index s of the block with index b has an absolute value higher than one (when 1), or not (when 0). If diu_coeff_abs_level_gtl[k][b][s][v] is not present it shall be inferred to be equal to 0.

diu_coeff_sign[k][b][s][v] indicates whether the k-th component of the displacement coefficient level associated with the vertex with index v of the subblock with index s of the block with index b has a positive sign (when 1), or not (when 0). If diu_coeff_sign[k][b][s][v] is not present it shall be inferred to be equal to 1.

diu_coeff_abs_level_rem[k][b][s][v] indicates the absolute value of the k-th component of the displacement coefficient level associated with the vertex with index v of the block with index b minus 2. If diu_coeff_abs_level_rem[k][b][s][v] is not present it shall be inferred to be equal to 0.

### J.7.3.6 Displacement Inter Data Unit Semantics

The arithmetic decoding engine is a context-separated, binary arithmetic decoder, performing binary renormalization and producing binary outputs.

The displacement residuals are derived from the arithmetic decoding. Same as A.7.3.5

### 3. Technical Problems Solved by Disclosed Technical Solutions

An example design for dynamic mesh coding has the following problems.

First, it is not clear how to deal with coding displacement data as a 4:2:2 video.

Second, the subblock size of AC-based coding should be constrained.

Third, the coding type and/or the reference index of AC-based displacement coding and those of submesh coding may be mismatched, which leads to unnecessary decoding latency.

Fourth, when coding displacement as a 4:0:0 video, in the current design, only one displacement component can be sent.

### 4. A Listing of Solutions and Embodiments

The detailed designs below should be considered as examples to explain general concepts. These examples should not be interpreted in a narrow way. Furthermore, these examples can be combined in any manner. Combinations between this disclosure and other disclosures are also applicable.
1. To solve problem 1, when displacement data are coded as a 4:2:2 video may be treated in the same way as 4:2:0 video.
   a. In one example, when DisplacementDim is equal to 1, the 1st displacement component is derived from the 1st colour component of the video and the 2nd and 3rd displacement components are inferred to be 0.
   b. In one example, when DisplacementDim is equal to 3, the 1st, 2nd and 3rd displacement components are derived from the 1st colour components of the video.
2. To solve problem 2, the subblock size of AC-based displacement coding shall be constrained.
   a. In one example, the subblock size of AC-based displacement coding shall be greater than 0.
   b. In one example, the subblock size of AC-based displacement coding shall be greater than 1.
3. To solve problem 3, the coding type of AC-based displacement coding may be aligned with the coding type of submesh.
   a. In one example, when smh_type indicates intra coded, e.g. being I_SUBMESH, dislp_type does not need to be signalled and may be inferred to be intra coded, e.g. being I_DISPLACEMENT.
      i. Alternatively, when dislp_type indicates intra coded, e.g. being I_DISPLACEMENT, smh_type does not need to be signalled and may be inferred to be intra coded, e.g. being I_SUBMESH.
   b. In one example, when smh_type indicates inter coded, e.g. being P_SUBMESH or SKIP_SUBMESH, dislp_type does not need to be signalled and may be inferred to be inter coded, e.g. being P_DISPLACEMENT.
      i. Alternatively, when dislp_type indicates inter coded, e.g. being P_DISPLACEMENT, smh_type may be inferred to be intra coded, e.g. being P_SUBMESH or SKIP_SUBMESH.
4. To solve problem 3, when a submesh at time t1 uses a submesh at time t2 as the reference, the displacement data at time t1 may only use the displacement data at time t2 as the reference.
   a. In one example, the reference index for the displacement is set equal to the reference index for the submesh.
   b. In one example, the displacement reference list structure is set equal to the same as the base mesh reference list structure (e.g., bmesh_ref_list_struct).
5. To solve problem 4, coding displacement data as a 4:0:0 video may be treated in the same way as 4:2:0 video.
   a. In one example, when displacement data are coded as a 4:0:0 video and DisplacementDim is equal to 1, the 1st displacement component is derived from the 1st colour component of the video and the 2nd and 3rd displacement components are inferred to be 0.
   b. In one example, when displacement data are coded as a 4:0:0 video DisplacementDim is equal to 3, the 1st, 2nd and 3rd displacement components are derived from the 1st colour components of the video.

### 5. Embodiments

Below are some example embodiments for the aspects summarized above in Section 4.

Most relevant parts that have been added or modified are in bold, and some of the deleted parts are in bold and italic fonts. There may be some other changes that are editorial in nature and thus not indicated.

The following text changes are based on WD 3.0 of V-DMC [3].

### 5.1 Embodiment 1

This embodiment is for item 1 as summarized above in Section 4.

### 11.5 Inverse Image Packing of Wavelet Coefficients

The wavelet coefficients inverse packing process proceeds as follows:

```
pixelsPerBlock = blockSize * blockSize
widthInBlocks = width / blockSize
shift = (1 << bitDepth) >> 1
blockCount = (verCoordCount + pixelsPerBlock − 1) / pixelsPerBlock
heightInBlocks = (blockCount + widthInBlocks − 1) / widthInBlocks
origHeight = heightInBlocks * blockSize
paddedHeight = height − 3 * origHeight
if ( !asps_vdmc_ext_1d_displacement_flag )
  start = (paddedHeight + origHeight) * width − 1
else
  start = (width * height) − 1
for( v = 0; v < verCoordCount; v++ ) {
  v0 = asps_vdmc_ext_packing_method ? start − v : v
  blockIndex = v0 / pixelsPerBlock
  indexWithinBlock = v0 % pixelsPerBlock
  x0 = ( blockIndex % widthInBlocks ) * blockSize
  y0 = ( blockIndex / widthInBlocks ) * blockSize
  ( x, y ) = computeMorton2D( indexWithinBlock )
  x1 = x0 + x
  y1 = y0 + y
  for( d = 0; d < DisplacementDim; d++ ) {
    if ( DecGeoChromaFormat == 4:2:0 ∥ DecGeoChromaFormat == 4:2:2 ) {
      dispQuantCoeffArray[ v0 ][ d ] =
        dispQuantCoeffFrame[ x1 ][ d * origHeight + y1 ][ d0 ] − shift
    } else {
      dispQuantCoeffArray[ v0 ][ d ] = dispQuantCoeffFrame[ x1 ][ y1 ][ d ] − shift
    }
  }
}
```

### 5.2 Embodiment 2

This embodiment is for item 5 as summarized above in Section 4.

### 11.5 Inverse Image Packing of Wavelet Coefficients

```
...
The wavelet coefficients inverse packing process proceeds as follows:
pixelsPerBlock = blockSize * blockSize
widthInBlocks = width / blockSize
shift = (1 << bitDepth) >> 1
blockCount = (verCoordCount + pixelsPerBlock − 1) / pixelsPerBlock
heightInBlocks = (blockCount + widthInBlocks − 1) / widthInBlocks
origHeight = heightInBlocks * blockSize
paddedHeight = height − 3 * origHeight
if ( !asps_vdmc_ext_1d_displacement_flag )
  start = (paddedHeight + origHeight) * width − 1
else
  start = (width * height) − 1
for( v = 0; v < verCoordCount; v++ ) {
  v0 = asps_vdmc_ext_packing_method ? start − v : v
  blockIndex = v0 / pixelsPerBlock
  indexWithinBlock = v0 % pixelsPerBlock
  x0 = ( blockIndex % widthInBlocks ) * blockSize
  y0 = ( blockIndex / widthInBlocks ) * blockSize
  ( x, y ) = computeMorton2D( indexWithinBlock )
  x1 = x0 + x
  y1 = y0 + y
  for( d = 0; d < DisplacementDim; d++ ) {
    if ( DecGeoChromaFormat == 4:2:0 ∥ DecGeoChromaFormat == 4:0:0 ) {
      dispQuantCoeffArray[ v0 ][ d ] =
        dispQuantCoeffFrame[ x1 ][ d * origHeight + y1 ][ d0 ] − shift
    } else {
      dispQuantCoeffArray[ v0 ][ d ] = dispQuantCoeffFrame[ x1 ][ y1 ][ d ] − shift
    }
  }
}
```

### 5.3 Embodiment 3

This embodiment is for items 1 and 5 as summarized above in Section 4.

### 11.5 Inverse Image Packing of Wavelet Coefficients

```
...
The wavelet coefficients inverse packing process proceeds as follows:
pixelsPerBlock = blockSize * blockSize
widthInBlocks = width / blockSize
shift = (1 << bitDepth) >> 1
blockCount = (verCoordCount + pixelsPerBlock − 1) / pixelsPerBlock
heightInBlocks = (blockCount + widthInBlocks − 1) / widthInBlocks
origHeight = heightInBlocks * blockSize
paddedHeight = height − 3 * origHeight
if ( !asps_vdmc_ext_1d_displacement_flag )
  start = (paddedHeight + origHeight) * width − 1
else
  start = (width * height) − 1
for( v = 0; v < verCoordCount; v++ ) {
  v0 = asps_vdmc_ext_packing_method ? start − v : v
  blockIndex = v0 / pixelsPerBlock
  indexWithinBlock = v0 % pixelsPerBlock
  x0 = ( blockIndex % widthInBlocks ) * blockSize
  y0 = ( blockIndex / widthInBlocks ) * blockSize
  ( x, y ) = computeMorton2D( indexWithinBlock )
  x1 = x0 + x
  y1 = y0 + y
  for( d = 0; d < DisplacementDim; d++ ) {
    if ( DecGeoChromaFormat == 4:2:0− DecGeoChromaFormat != 4:4:4 ) {
      dispQuantCoeffArray[ v0 ][ d ] =
        dispQuantCoeffFrame[ x1 ][ d * origHeight + y1 ][ d0 ] − shift
    } else {
      dispQuantCoeffArray[ v0 ][ d ] = dispQuantCoeffFrame[ x1 ][ y1 ][ d ] − shift
    }
  }
}
```

### 6. References

[1] MPEG technical requirements, “CfP for. Dynamic Mesh Coding,” ISO/IEC JTC 1/SC 29/WG 2 doc. no. N145, in October 2021.
[2]K. Mammou, J. Kim, A. Tourapis and D. Podborski, “[V-CG] Apple's Dynamic Mesh Coding CfP Response,” ISO/IEC JTC 1/SC 29/WG 7 doc. no. m59281, in April 2022.
[3] MPEG output document, “WD 3.0 of V-DMC,” ISO/IEC JTC 1/SC 29/WG 7 doc. no. N00611, in April 2023.
[4]C. Huang, X. Xu, X. Zhang, J. Tian and S. Liu, “Investigation of video coding of motion fields,” ISO/IEC JTC 1/SC 29/WG 7 doc. no. m61005, in July 2022.

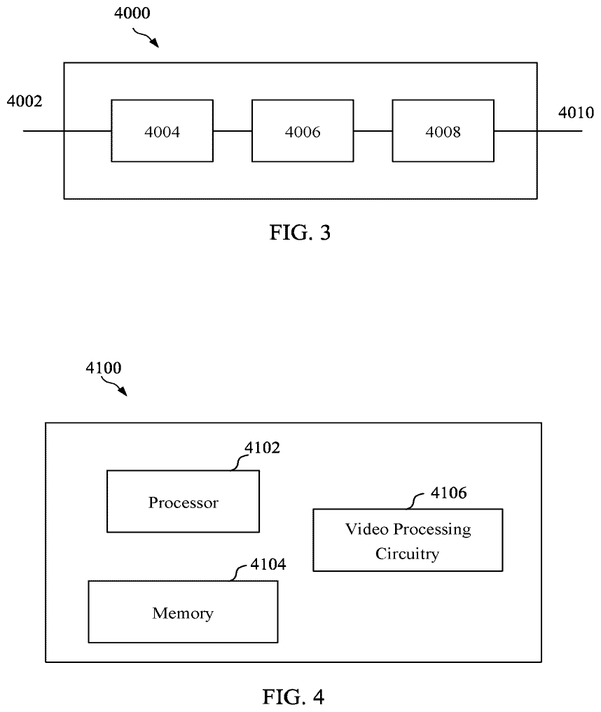

FIG. 3 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as wireless fidelity (Wi-Fi) or cellular interfaces.

The system 4000 may include a coding component 4004 that may implement the various coding or encoding methods described in the present disclosure. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include serial advanced technology attachment (SATA), peripheral component interconnect (PCI), integrated drive electronics (IDE) interface, and the like. The techniques described in the present disclosure may be embodied in various electronic devices such as mobile phones, laptops, smartphones or other devices that are capable of performing digital data processing and/or video display.

FIG. 4 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present disclosure. The memory (memories) 4104 may be used for storing data and code used for implementing the methods and techniques described herein. The video processing circuitry 4106 may be used to implement, in hardware circuitry, some techniques described in the present disclosure. In some embodiments, the video processing circuitry 4106 may be at least partly included in the processor 4102, e.g., a graphics co-processor.

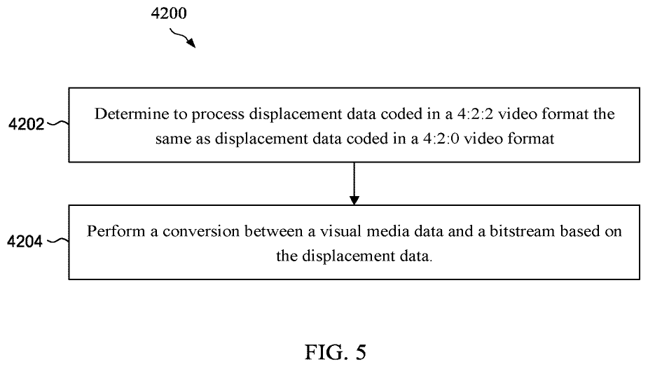

FIG. 5 is a flowchart for an example method 4200 of video processing. In block 4202, the method 4200 comprises determining to process displacement data coded in a 4:2:2 video format the same as displacement data coded in a 4:2:0 video format. In block 4204, a conversion between a visual media data and a bitstream based on the displacement data is performed. The conversion may include encoding at an encoder, decoding at a decoder, or combinations thereof.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

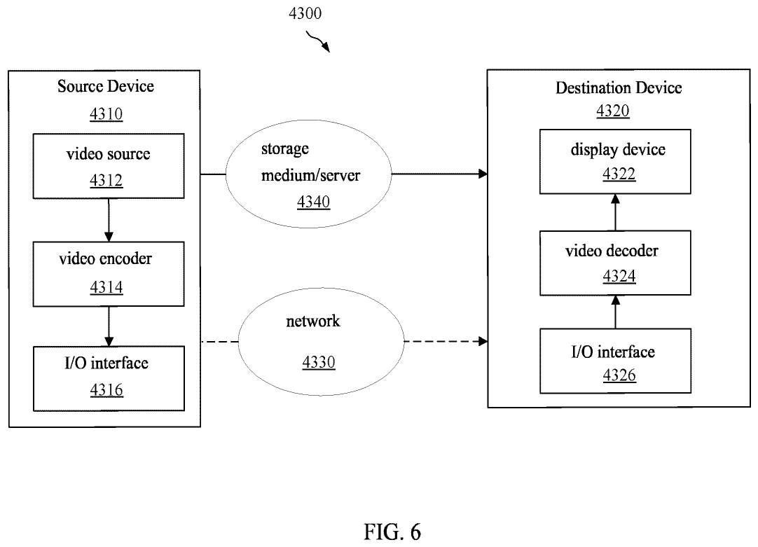

FIG. 6 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

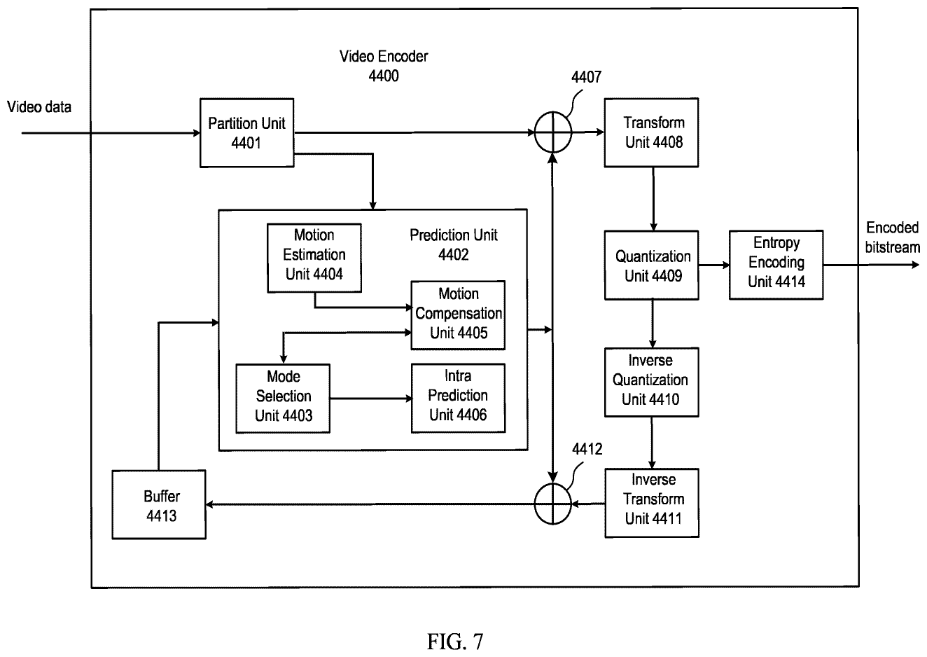

FIG. 7 is a block diagram illustrating an example of video encoder 4400, which may be video encoder 4314 in the system 4300 illustrated in FIG. 6. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode select unit 4403, a motion estimation unit 4404, a motion compensation unit 4405, an intra prediction unit 4406, a residual generation unit 4407, a transform processing unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

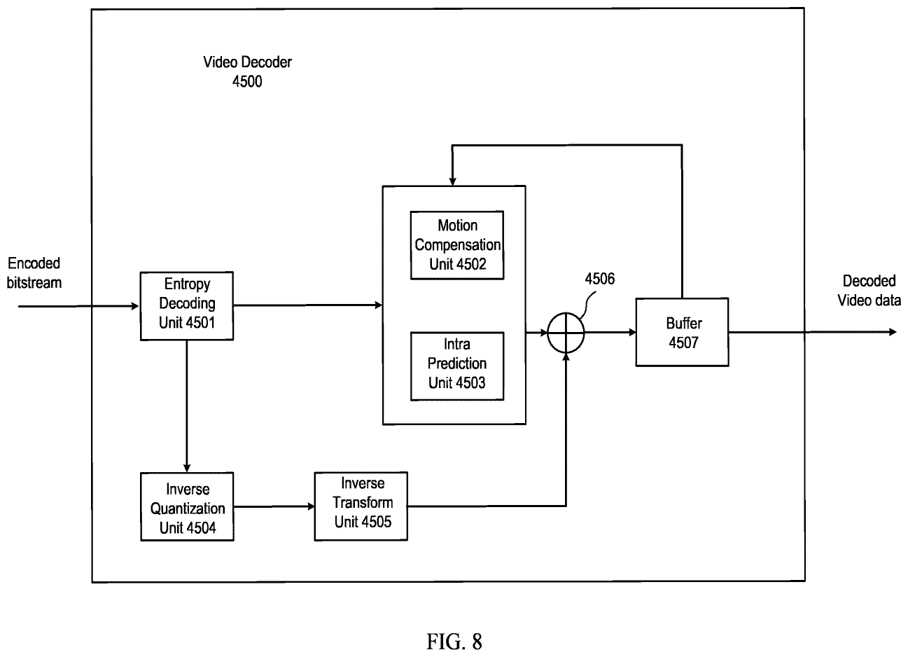

FIG. 8 is a block diagram illustrating an example of video decoder 4500 which may be video decoder 4324 in the system 4300 illustrated in FIG. 6. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

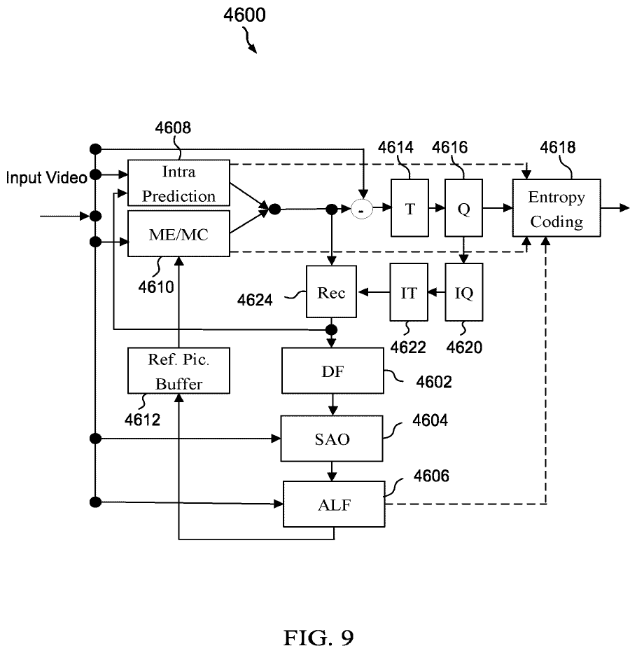

FIG. 9 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of techniques discussed herein.
1. A method for processing media data comprising: determining when displacement data are coded as a 4:2:2 video, the video is treated in a same way as 4:2:0 video; and performing a conversion between a visual media data and a bitstream based on the displacement data.
2. The method of solution 1, wherein when DisplacementDim is equal to 1, the 1st displacement component is derived from the 1st colour component of the video and the 2nd and 3rd displacement components are inferred to be 0.
3. The method of any of solutions 1-2, wherein when DisplacementDim is equal to 3, the 1st, 2nd and 3rd displacement components are derived from the 1st colour components of the video.
4. The method of any of solutions 1-3, wherein a subblock size of AC-based displacement coding shall be constrained.
5. The method of any of solutions 1-4, wherein the subblock size of AC-based displacement coding shall be greater than 0 or greater than 1.
6. The method of any of solutions 1-5, wherein the coding type of AC-based displacement coding is aligned with the coding type of submesh.
7. The method of any of solutions 1-6, wherein when smh_type indicates intra coded according to I_SUBMESH, dislp_type does not need to be signalled and may be inferred to be intra coded according to I_DISPLACEMENT.
8. The method of any of solutions 1-7, wherein when dislp_type indicates intra coded according to I_DISPLACEMENT, smh_type does not need to be signalled and may be inferred to be intra coded according to I_SUBMESH.
9. The method of any of solutions 1-8, wherein when smh_type indicates inter coded according to P_SUBMESH or SKIP_SUBMESH, dislp_type does not need to be signalled and may be inferred to be inter coded according to P_DISPLACEMENT.
10. The method of any of solutions 1-9, wherein when dislp_type indicates inter coded according to P_DISPLACEMENT, smh_type may be inferred to be intra coded according to P_SUBMESH or SKIP_SUBMESH.
11. The method of any of solutions 1-10, wherein when a submesh at time t1 uses a submesh at time t2 as the reference, the displacement data at time t1 may only use the displacement data at time t2 as the reference.
12. The method of any of solutions 1-11, wherein the reference index for the displacement is set equal to the reference index for the submesh.
13. The method of any of solutions 1-12, wherein the displacement reference list structure is set equal to the same as the base mesh reference list structure according to bmesh_ref_list_struct.
14. The method of any of solutions 1-13, wherein coding displacement data as a 4:0:0 video is treated in a same way as 4:2:0 video.
15. The method of any of solutions 1-14, when displacement data are coded as a 4:0:0 video and DisplacementDim is equal to 1, the 1st displacement component is derived from the 1st colour component of the video and the 2nd and 3rd displacement components are inferred to be 0.
16. The method of any of solutions 1-15, when displacement data are coded as a 4:0:0 video DisplacementDim is equal to 3, the 1st, 2nd and 3rd displacement components are derived from the 1st colour components of the video.
17. An apparatus for processing video data comprising: a processor; and a non-transitory memory with instructions thereon, wherein the instructions upon execution by the processor, cause the processor to perform the method of any of solutions 1-16.
18. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-16.
19. A non-transitory computer-readable recording medium storing a bitstream of a video which is generated by a method performed by a video processing apparatus, wherein the method comprises: determining when displacement data are coded as a 4:2:2 video, the video is treated in a same way as 4:2:0 video; and generating a bitstream based on the determining.
20. A method for storing bitstream of a video comprising: determining when displacement data are coded as a 4:2:2 video, the video is treated in a same way as 4:2:0 video; generating a bitstream based on the determining; and storing the bitstream in a non-transitory computer-readable recording medium.
21. A method, apparatus, or system described in the present disclosure.

The following solutions show further examples of techniques discussed herein.
1. A method for processing media data, comprising: determining to process displacement data coded in a 4:2:2 video format the same as displacement data coded in a 4:2:0 video format; and performing a conversion between a visual media data and a bitstream based on the displacement data.
2. The method of solution 1, wherein when a displacement dimension (DisplacementDim) is equal to 1, a first displacement component is derived from a first color component of a video and a second displacement component and a third displacement component are inferred to be 0.
3. The method of solution 1, wherein when a displacement dimension (DisplacementDim) is equal to 3, a first displacement component, a second displacement component, and a third displacement component are derived from a first color component of the video.
4. The method of any of solutions 1-3, wherein a subblock size of alternating current (AC)-based displacement coding is constrained to being greater than a particular value.
5. The method any of solutions 1-3, wherein the subblock size of AC-based displacement coding is constrained to being greater than 0.
6. The method any of solutions 1-3, wherein the subblock size of AC-based displacement coding is constrained to being greater than 1.
7. The method of solution 1, further comprising determining to process displacement data coded in a 4:0:0 video format the same as the displacement data coded in a 4:2:0 video format.
8. The method of solution 7, wherein when the displacement data is coded in the 4:0:0 video format and a displacement dimension (DisplacementDim) is equal to 1, a first displacement component is derived from a first color component of a video and a second displacement component and a third displacement component are inferred to be 0.
9. The method of solution 7, wherein when the displacement data is coded in the 4:0:0 video format and a displacement dimension (DisplacementDim) is equal to 3, a first displacement component, a second displacement component, and a third displacement component are derived from a first color component of the video.
10. The method of solution 1, further comprising aligning a coding type of alternating current (AC)-based displacement coding with a coding type of a submesh.
11. The method of solution 10, wherein when a coding type of the current submesh (smh_type) indicates intra coding, a coding type of a current displacement frame (displ_type) is not signalled in the bitstream and is inferred to be intra coded.
12. The method of solution 10, wherein when a coding type of a current displacement frame (displ_type) indicates intra coding, a coding type of the current submesh (smh_type) is not signalled in the bitstream and is inferred to be intra coded.
13. The method of any of solutions 11-12, wherein the smh_type has a submesh type of I_SUBMESH, and wherein the displ_type has a type of I_DISPLACEMENT.
14. The method of solution 10, wherein when a coding type of the current submesh (smh_type) indicates inter coding, a coding type of a current displacement frame (displ_type) is not signalled in the bitstream and is inferred to be inter coded.
15. The method of solution 10, wherein when a coding type of a current displacement frame (displ_type) indicates inter coding, a coding type of the current submesh (smh_type) is not signalled in the bitstream and is inferred to be inter coded.
16. The method of any of solutions 14-15, wherein the smh_type has a submesh type of P_SUBMESH or SKIP_SUBMEDH, and wherein the displ_type has a type of P_DISPLACEMENT.
17. The method of any of any of solutions 1-16, wherein when a submesh at a first time (t1) uses a submesh at a second time (t2) as a reference, displacement data at the first time only uses displacement data at the second time as a reference.
18. The method of solution 17, wherein a reference index for displacement data is set equal to a reference index for submesh.
19. The method of solution 17, wherein a displacement reference list structure is set equal to a base mesh reference list structure.
20. The method of solution 19, wherein the base mesh reference list structure is designated bmesh_ref_list_struct.
21. The method of any of solutions 1-20, wherein one or more of the 4:2:2 video format, the 4:0:0 video format, and the 4:2:0 video format comprise a chroma video format (videoChromaFormat).
22. The method of any of solutions 1-20, wherein one or more of the 4:2:2 video format, the 4:0:0 video format, and the 4:2:0 video format comprise a decoding geometry video format (DecGoeChromaFormat).
23. The method of any of solutions 1-22, wherein the conversion includes encoding the media data into the bitstream.
24. The method of any of solutions 1-22, wherein the conversion includes decoding the media data from the bitstream.
25. An apparatus for processing video data comprising: a processor; and a non-transitory memory with instructions thereon, wherein the instructions upon execution by the processor, cause the processor to perform the method of any of solutions 1-24.
26. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-24.
27. A non-transitory computer-readable recording medium storing a bitstream of a video which is generated by a method performed by a video processing apparatus, wherein the method comprises: determining to process displacement data coded in a 4:2:2 video format the same as displacement data coded in a 4:2:0 video format; and generating the bitstream based on the displacement data.
28. A method for storing bitstream of a video, comprising: determining to process displacement data coded in a 4:2:2 video format the same as displacement data coded in a 4:2:0 video format; generating the bitstream with the based on the displacement data; and storing the bitstream in a non-transitory computer-readable recording medium.
29. A method, apparatus, or system described in the present disclosure.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present disclosure, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field programmable gate array (FPGA) or an application specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of particular techniques. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing media data, comprising:
performing a conversion between displacement data for dynamic mesh coding and a bitstream according to a format rule, wherin the displacement data is represented as a video, and
wherein the format rule specifies that a displacement component of the displacement data is derived from a color component of the video based on a video format for coding the displacement data being a specific video format and a value of a displacement dimension varible (DisplacementDim), and the specific video format comprises at least one of a 4:2:0 video format, a 4:2:2 video format, or a 4:0:0 video format.

2. The method of claim 1, wherein in a case where the video format for coding the displacement data is the specific video format, when the value of DisplacementDim is equal to 1, a first displacement component of the displacement data is derived from a first color component of the video, and a second displacement component and a third displacement component of the displacement data are inferred to be 0.

3. The method of claim 1, wherein in a case where the video format for coding the displacement data is the specific video format, when the value of DisplacementDim is equal to 3, a first displacement component, a second displacement component, and a third displacement component of the displacement data are derived from a first color component of the video.

4. The method of claim 1, wherein a subblock size of alternating current (AC)-based displacement coding is constrained to being greater than a particular value.

5. The method of claim 4, wherein the subblock size of AC-based displacement coding is constrained to being greater than 0.

6. The method of claim 4, wherein the subblock size of AC-based displacement coding is constrained to being greater than 1.

7. The method of claim 1, wherein the video format for coding the displacement data is indicated by a varible videoChromaFormat in the bitstream.

8. The method of claim 1, further comprising aligning a coding type of alternating current (AC)-based displacement coding with a coding type of a submesh, wherein when a coding type of a current submesh (smh_type) indicates intra coding, a coding type of a current displacement frame (displ_type) is not signalled in the bitstream and is inferred to be intra coded, and when the coding type of the current displacement frame (displ_type) indicates intra coding, the coding type of the current submesh (smh_type) is not signalled in the bitstream and is inferred to be intra coded, and
wherein the smh_type has a submesh type of I_SUBMESH, and wherein the displ_type has a type of I_DISPLACEMENT.

9. The method of claim 1, further comprising aligning a coding type of alternating current (AC)-based displacement coding with a coding type of a submesh, wherein when a coding type of a current submesh (smh_type) indicates inter coding, a coding type of a current displacement frame (displ_type) is not signalled in the bitstream and is inferred to be inter coded, and when the coding type of the current displacement frame (displ_type) indicates inter coding, a coding type of the current submesh (smh_type) is not signalled in the bitstream and is inferred to be inter coded, and
wherein the smh_type has a submesh type of P_SUBMESH or SKIP_SUBMEDH, and wherein the displ_type has a type of P_DISPLACEMENT.

10. The method of claim 1, wherein when a submesh at a first time (t1) uses a submesh at a second time (t2) as a reference, displacement data at the first time only uses displacement data at the second time as a reference,
wherein a reference index for displacement data is set equal to a reference index for submesh, and
wherein a displacement reference list structure is set equal to a base mesh reference list structure.

11. The method of claim 1, wherein displacement data coded as the 4:2:2 video format is treated in the same way as displacement data coded as the 4:2:0 video format.

12. The method of claim 1, wherein displacement data coded as the 4:0:0 video format is treated in the same way as displacement data coded as the 4:2:0 video format.

13. The method of claim 10, wherein the base mesh reference list structure is designated bmesh_ref_list_struct.

14. The method of claim 1, wherein the value of DisplacementDim is determined based on a value of a flag, when the value of the flag is equal to 1, the value of DisplacementDim is set equal to 1, and when the value of the flag is equal to 0, the value of DisplacementDim is set equal to 3.

15. The method of claim 1, wherein the conversion includes encoding the video into the bitstream.

16. The method of claim 1, wherein the conversion includes decoding the video from the bitstream.

17. The method of claim 15, wherein the bitstream together with a first bitstream for representing a base mesh and a second bitstream for representing an attribute map are used for a dynamic mesh decoding to reconstruct a 3D midea data.

18. An apparatus for processing media data comprising a processor and a non-transitory memory with instructions thereon, wherein the instructions upon execution by the processor, cause the processor to:
perform a conversion between displacement data for dynamic mesh coding and a bitstream according to a format rule, wherin the displacement data is represented as a video, and
wherein the format rule specifies that a displacement component of the displacement data is derived from a color component of the video based on a video format for coding the displacement data being a specific video format and a value of a displacement dimension varible (DisplacementDim), and the specific video format comprises at least one of a 4:2:0 video format, a 4:2:2 video format or a 4:0:0 video format.

19. A non-transitory computer-readable storage medium storing instructions that cause a processor to:
perform a conversion between displacement data for dynamic mesh coding and a bitstream according to a format rule, wherin the displacement data is represented as a video, and
wherein the format rule specifies that a displacement component of the displacement data is derived from a color component of the video based on a video format for coding the displacement data being a specific video format and a value of a displacement dimension varible (DisplacementDim), and the specific video format comprises at least one of a 4:2:0 video format, a 4:2:2 video format or a 4:0:0 video format.

20. A non-transitory computer-readable recording medium storing a bitstream of a video which is generated by a method performed by a video processing apparatus, wherein the method comprises:
generating the bitstream from displacement data for dynamic mesh coding according to a format rule, wherin the displacement data is represented as the video, and
wherein the format rule specifies that a displacement component of the displacement data is derived from a color component of the video based on a video format for coding the displacement data being a specific video format and a value of a displacement dimension varible (DisplacementDim), and the specific video format comprises at least one of a 4:2:0 video format, a 4:2:2 video format or a 4:0:0 video format.
